(19) United States
(12) Patent Application Publication
(10) Pub. No.: US 2014/0330407 A1
(43) Pub. Date: Nov. 6, 2014

(54) Intelligent Reconfigurable Locker System

(71) Applicants: Thomas Corder, San Leandro, CA (US); James Mullin, San Leandro, CA (US)

(72) Inventors: Thomas Corder, San Leandro, CA (US); James Mullin, San Leandro, CA (US)

(21) Appl. No.: 14/267,892

(22) Filed: May 1, 2014

Related U.S. Application Data
(60) Provisional application No. 61/818,362, filed on May 1, 2013.
(60) Provisional application No. 61/926,317, filed on Jan. 11, 2014.

(51) Int. Cl. G05B 15/02

(52) U.S. Cl. CPC G05B 15/02
USPC 700/90

(57) ABSTRACT

This invention involves the configuration of locker sizes during installation that can be reconfigured periodically to conform to the packages that arrive at the locker location. Locker control software can enable the efficient selection of locker size so that the locker bank can be optimized to the size of the packages that are delivered to the locker location. The reconfigurable lockers also may include a modular locker control module that can assist in the easy facilitation of changing the locker size. Also, the locker software can be flexible enough so that customers can have a direct communication link to the locker software that would allow the customer's mobile device to input authentication and access codes that would open up locker door(s). The locker software could also be enabled on the cloud providing an e-commerce goods seller, shipper or locker operator with information about goods that are shipped to locker locations and when customers stop by to pick up their goods or to return their goods to the e-commerce seller.

### PRIOR CLAIM OF PRIORITY

This invention claims priority to U.S. Provisional Patent Application No. 61/818,362 filed on May 1, 2013 titled “Intelligent Configurable Locker System” and U.S. Provisional Patent Application No. 61/926,317 filed on Jan. 11, 2014 titled “Intelligent Configurable Locker System,” both of which are incorporated by reference.

### BACKGROUND OF THE INVENTION

1. Field of the Invention

This invention provides an intelligent locker system with a capability of having reconfigurable locker sizes. Specifically, this invention relates to an intelligent re-configurable locker storage system that can be used to store goods and personal belongings.

2. Related Art

Numerous locker systems are commercially available for storage of personal items at differing venues including health clubs, schools, businesses, transportation terminals, amusement parks and ski areas. Some are mechanical systems that are controlled by a mechanical key while others are electronic systems that may be networked together or, in some cases, the individual lockers may be standalone. Many of these electronic systems include self-service kiosks for the operator and consumer to use to access a specified locker.

A need exists for a new category of electronically operated lockers to support the changing lifestyles of today's consumers. Today, consumers are increasingly ordering products on-line instead of relying upon traditional brick and mortar retailers. This has created a new industry of virtual merchants that do not have the fixed overhead cost of the traditional brick and mortar retailers. As a result, virtual online merchants are able to sell products at a lower price, which is having a significant negative impact on the sales of traditional retailers. In addition, increasingly consumers are show rooming products. Meaning, the consumer shops at a traditional retailer and to select the product, and once the product selection is made, the consumer goes home and places an online order or uses their mobile device to find the lowest price for the product while the consumer is still inside the traditional retailer's store. To combat these new on-line retailers, traditional brick and mortar retailers have begun to establish their own online sales operations. The result has created a new competition for the most rapid and efficient solution for delivering the items ordered online.

Also, many online retailers are seeking ways to cost effectively deliver goods to online customers in a same day or next day delivery schedule. Such a desired goal, while worthwhile, is frustrated if the customer is not at the delivery location at the time of the actual delivery. Thus, a need exists for a delivery methodology that cost effectively ensures same day or next day delivery for online orders of goods.

One on-line, or virtual, retailer has seized the initiative for efficient delivery by deploying automated self-service, locker based delivery systems that are located in synergistic retail locations, such as convenience stores and coffee shops, that are open during extended operating hours. This solution enables consolidation of deliveries of numerous orders placed by neighboring consumers to be delivered to one location. Furthermore, the consumer can retrieve their online orders anytime that the local delivery location is open for business. This solution has actually made it possible for online retailers to offer free “next day” delivery while requiring the consumer to go the “last mile” to retrieve their package.

To use the self-service locker delivery system, the consumer places their order on-line and selects the most convenient location the on-line retailer offers to pick up their package. The on-line retailer may use a well-known national delivery service or a local delivery service to deliver the package to the locker system. As part of the process, the driver will scan or manually enter specific information about the delivery including the order number, location, and time of delivery and possibly the locker information. This delivery information is typically sent to the consumer via email or text message, notifying them that their order has been delivered to the specified location. In some cases, the consumer may simply be called to notify them of the delivery details.

While online retailers are forced to establish delivery locations that are open for extended hours, traditional retailers have the advantage of using a “ship to store” business model. A ship-to-store business model means that the package ordered on-line from the retailer's web site will be shipped to the retailer's store nearest to the consumer at a reduced or no shipping charge to the consumer. Once the goods arrive, the customer has to travel to the store to retrieve the goods.

At least one traditional retailer has established a successful ship-to-store model where the consumer can order items online that are not available at the store. Retailers employing this business model have so far depended on store personnel at the service counter to both stock the items when they are delivered to the store and fulfill the order when the consumer arrives seeking to pick up their online ordered goods at the store. When online shopping customers arrive during peak shopping hours, these sales associates are often picking orders for on-line customers and are not servicing the retail customers that are choosing to shop the retail store aisles. While improving service for the on-line customer, store service for retail shoppers actually declines and conflicts development between the retail divisions and online divisions in retail corporations.

Some brick and mortar retailers have begun to test the ship-to-store business model concept utilizing automated, self-service, delivery lockers in their retail locations. These systems typically include a self-service kiosk with a touch-screen user interface and a bank of lockers controlled by the kiosk. In a typical system, the store associate or delivery person would select a locker, open the locker by authenticating with a code, order number or other authentication factor, and then place the package in the locker. This process can be automated by the use of bar-code scanners and software capable of selecting the locker. The consumer is then notified, typically by email, text or phone call from customer service that the package has been “delivered” to a locker location near to the consumer. The consumer can stop by the retail location at their convenience and retrieve their package by entering an authorization code or by scanning their smart phone at the kiosk, which serves as identification to open the appropriate locker. To prevent theft, a second form of identification may also be required by the retailer before the consumer can open the locker and retrieve their online purchases.

International and regional express delivery firms have also begun to recognize the potential benefits of self-service delivery lockers. The high cost of delivery at individual residences could be reduced and the cost of re-delivery of packages that is needed when the individual consumer is not home could potentially be eliminated if the packages could be re-directed to a nearby locker system. In addition, an opportunity exists to mitigate the high cost that results from the theft of packages that are left on doorsteps by delivery firms.

Another use application for delivery firms is deployment of lockers at the delivery firm's central depots, where customers are often forced to go to pick up packages because of missed delivery or related problems. The depots are often heavily burdened with customers at the same time of day—morning, lunch time and evenings. It is difficult for the delivery firms to have sufficient manpower available for peak rush times. An intelligent locker system could be installed and equipped with an electronic sign that would notify customers that their package is in the locker system and can be retrieved with appropriate authentication.

The cost of manufacturing the locker system, along with the shipping and installation cost, is a main concern of both brick and mortar retailers and delivery firms. For a locker delivery system to be economically viable, the efficiency of the system must be maximized. Besides being able to handle a large volume of orders, a critical component in utilization is optimizing the number and relative size of the individual lockers. Too many large sized lockers will disproportionately decrease the overall number of lockers available for consumer package delivery, while too few large openings will limit the number of larger packages that can be accepted at a given time, thus slowing delivery. An inefficient mix of individual locker sizes will result in one size of lockers being unused while another size is full and packages of that size are delayed delivery.

Additional shortcomings of existing locker solutions include accountability of the delivery person as well as with the consumer. In current systems, it would be possible for a locker operator to open a locker, but not actually “deliver” the package by inserting it into the locker, either by honest mistake or because the delivery person is unscrupulous. Conversely, it is possible for a customer to actually remove their package, but claim the ordered goods were not in the locker when the customer went to retrieve the goods. In both scenarios, there is no accountability of either party as to the insertion or removal of the package. There are other scenarios where it would be beneficial for the operator of the locker system to know if a package were in a locker or whether the locker was empty.

Other concerns and shortcomings include the inability to install and service the locker systems rapidly and the inability to scale a system to numerous locations, including international markets. It will almost certainly be too expensive to ship locker cabinets from one country to another country, especially when considering duty costs and other local taxes. Locker cabinets are the actual sheet metal that forms the locker space.

Most existing locker systems being deployed in the market are based on modifications or adaptations of traditional lockers. These solutions require the electronic components such as the locks and cables to be installed into the locker cabinets by a hand fitting process, that can be expensive and results in poor quality issues arising due to tight fits and sharp edges that can damage the cables. In addition, the process must either be performed at the locker cabinet manufacturers' facilities, who may not be experts in electronic assembly, or worse yet; the connection of the electronics including the electronic cables may be connected in the field at the locker's installation at a job site. In such scenarios, assembly and testing may result in high cost, poor reliability, or both.

This problem is magnified when considering international markets. Locker cabinet manufacturers located in different regions of the world will likely utilize different designs and manufacturing techniques, which will simply magnify the problem of fitting the electronic locket components to the individual manufacturers' cabinets.

Furthermore, the locker systems that are currently available do not offer configuration flexibility to account for the local demographics or changes in package sizes that might occur over time. This means that if the retailer or shipper operating a system does not install the optimal mix of locker sizes for a particular location they will have to experience an expensive retrofit or replacement process to change the mix of locker sizes. Thus, additional needs exist for a flexible locker configuration capability allowing the operator to change the locker size and mix of openings in order to optimize utilization of space. Traditional locker systems require that existing cabinets of lockers be removed and new cabinets with different locker sizes be installed. There is a significant cost of material, freight and labor to switch cabinets and there would likely be scrap material unless the removed cabinet and associated electro-mechanical hardware could be re-commissioned. Furthermore, a significant reprogramming effort is needed to update the locker system software to utilize the new configuration. Thus, a need exists for a rapidly reconfigurable locker system that can be sized based on the delivery of packages for a given time period.

### SUMMARY

This invention facilitates configuration of locker sizes both during installation and facilitates reconfiguration after the lockers are installed. The locker control software enables efficient selection of one or more lockers to accept delivery of packages or even multiple packages from one order. The lockers facilitate access by the customer who arrives to pick-up their order. The same software also enables a quick and simple setup and reconfiguration of the lockers by use of network addressable locker control modules that are preaddressed at the factory or may be set at the local site by a barcode scanner, manual key entry or by a set of position switches that form an address. Alternatively, network addresses may be downloaded to the locker control modules either by the locker control unit or remotely from a server over a wide-area network.

This invention provides a system of mechanically and electronically reconfigurable and addressable lockers that comprise an intelligent locker system. The intelligent locker system comprises a plurality of lockers allowing an operator to easily reconfigure the locker sizes to accommodate a changing size and delivery schedules of packages and products that will be temporarily stored in the lockers. The locker system may also include at least one locker control column connecting a locker lock mechanism with a kiosk having a man—machine interface by a wired or wireless communication network.

A locker control column can be constructed to provide a modular platform that may support a lock mechanism, a controller, sensor(s), LED lights and a connection for the locker control module to connect to cabling supplying power and a wired communication link. The locker control column may be manufactured separate and distinct from the locker cabinets (locker structure) and assembled by an installer in a field location. Such a locker control column could substantially simplify the assembly, diagnosis and maintenance as the locker control modules could be modular enabling a simplification of the cabling for power and locker door configuration with the lock itself.

Furthermore, the invention provides for use of sensors to determine the status of a locker door and the presence of a package in a locker. A set of visual and audible status indicators are also included that assist the locker operator and/or the user or customer who may pick up packages stored in the individual lockers. Information from the sensors may also be used to provide tamper and security alerts and to provide verification that a package has been delivered and later removed from the locker.

The invention additionally provides for an electronic signaling system operating over a network that can provide notice of package pickup availability as well as access code(s) to authenticate and access the locker holding a customer's package. Such a signaling system may dynamically update and notify customers that their packages are available for retrieval in the locker system.

One embodiment of the easily reconfigurable locker system is designed so that users can place online orders for later pick up at a brick and mortar location having the locker system. In some instances, the pick-up location can be at an actual retail store. In other instances, the pick-up location may be places of high traffic such as a parking garage, shopping mail, grocery store or a mail pick up location. The use of an intelligent locker storage and delivery system would free up workers at the location. Since the goods placed in the lockers are already paid for by the user, the locker location can be located at a less secure location, e.g. outside area of the retail store so users can stop by and pick up their purchased goods during hours when the retail store is not open.

As merchants sell their products online and try to speed up the delivery of goods to the customer, customers can purchase goods online and the goods can be pulled from a retail store's existing inventory, or pulled from a distribution location and delivered to a locker location within hours of the online purchase. Once the goods arrive at the locker location, the locker operator can configure the locker(s) standard size so that larger goods can occupy more than one standard sized locker. Authentication information, such as an access code is then sent to the customer via email, text or telephone call so that when the customer arrives at the locker location, the customer inputs their access code or other means of authentication information and the locker or lockers automatically unlock or open, allowing the customer to retrieve the purchased goods.

By allowing the locker operator to easily reconfigure locker sizes, the locker operator can optimize the locker configuration to hold odd sized goods. The locker operator can remove shelves in the locker cabinet and with the graphical user interface supported by the central control unit, the locker operator can reconfigure the lock control modules so that the current sized locker doors are integrally connected or replaced to form a single locker door. For example, if a purchased good can fit in three standard sized lockers, the locker operator can remove two of the shelves, configure the three locker doors so that they are connected and open as one locker door. Alternatively, the operator could remove the shelves as described and replace the three standard doors with one large door. Thus, when the customer arrives at the locker location and inputs their authentication information such as an access code, the locker door comprising three standard sized locker doors will open and the customer can remove the large sized purchased item.

As installation of intelligent locker delivery systems grow, it will become increasingly important for the operator to know whether or not a package is in a specific locker. One embodiment of the invention is the use of infrared emitters and receiver technologies to detect the presence of a package in a locker.

Two of the main obstacles in the use of sensor technology are the coverage of the entire locker and the cost of the sensor technology. If not properly implemented, small packages such as letters will be difficult to detect or the cost of the sensor technology may become prohibitive. The current invention may be employed to use a combination of at least one sensor and at least one indicator to detect and to indicate the presence of a package, which is then communicated to a locker operator or the merchant who shipped the package(s) to the locker system.

Existing locker systems do not provide the capability to monitor whether or not a package is present in a particular locker. Sensors and/or indicators may be used to monitor the presence of a package and provide feedback to the locker operator and/or merchant, thus improving accountability, reliability, operation and security of the locker system by gathering information as to when a package is actually inserted or removed from a specific locker.

While there is more than one sensor technology that may be employed to detect the presence of a package, current locker systems lack a cost effective and reliable method to detect a package. One reason may be the difficult challenge it difficult to detect small packages and letter sized envelopes that could be placed in a locker.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE DRAWINGS

The components in the figures are not necessarily to scale, emphasis being placed instead upon illustrating the principles of the invention. In the figures, like reference numerals designate corresponding parts throughout the different views.

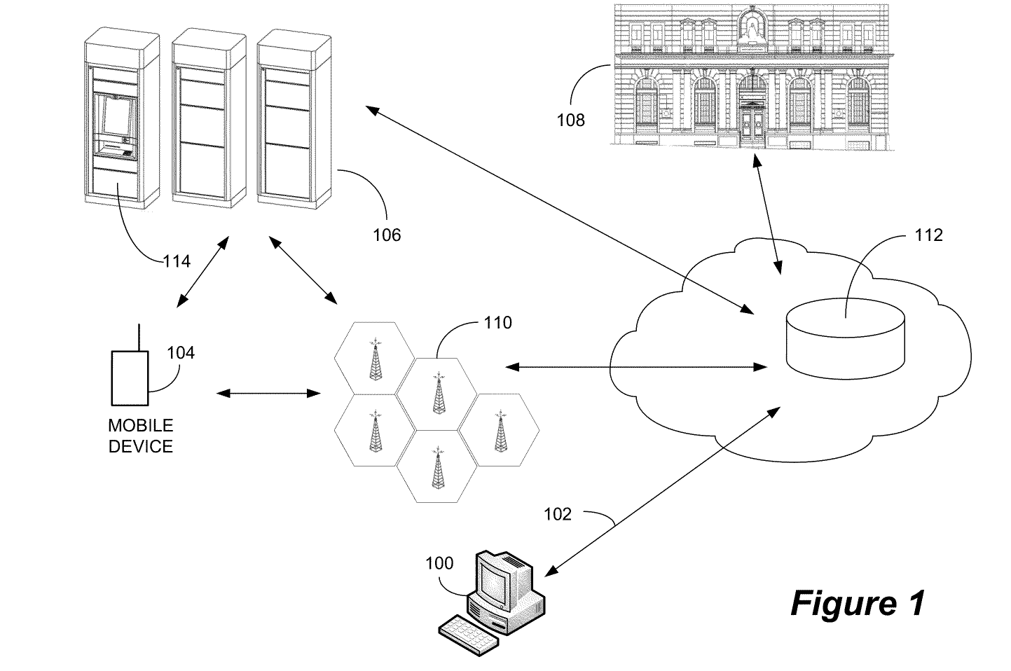

FIG. 1 is a block diagram illustrating the communication pathways between a locker system having a kiosk and the customer.

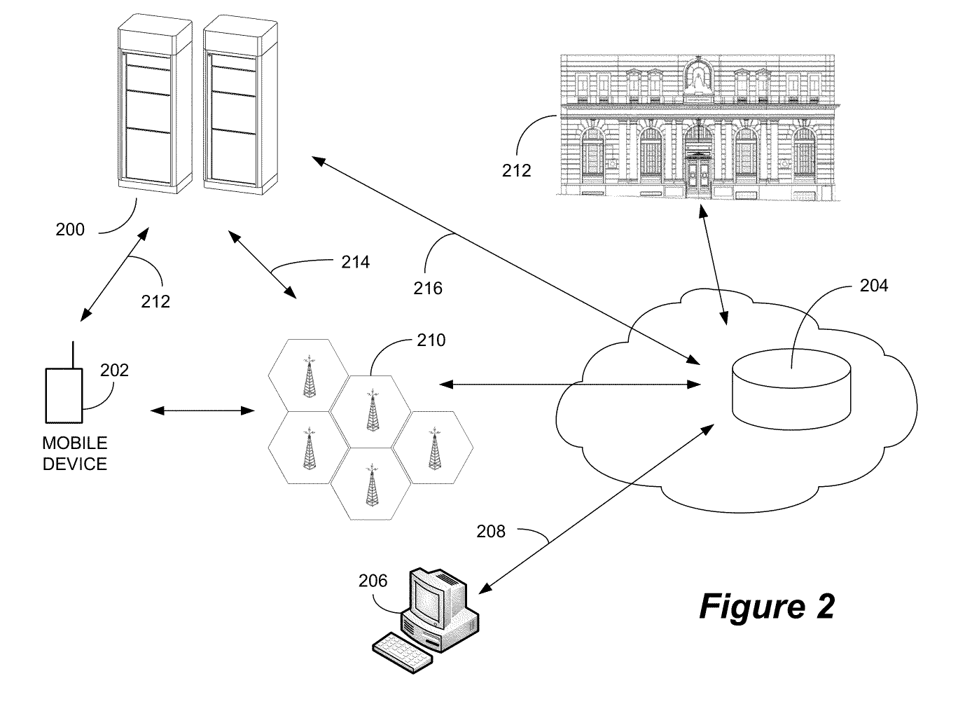

FIG. 2 is a block diagram illustrating the communication pathways between a locker system without a kiosk and the customer.

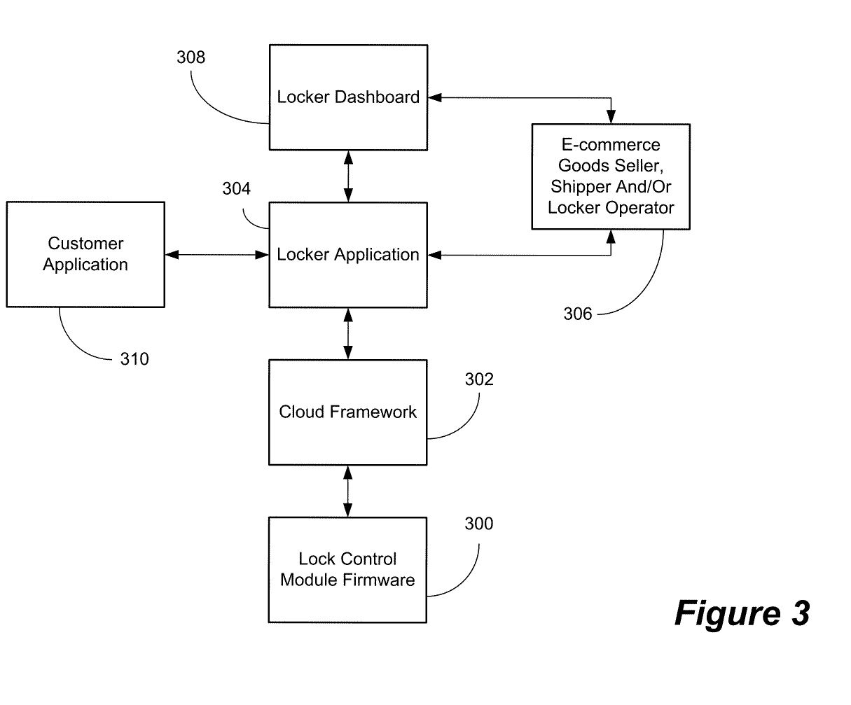

FIG. 3 is a block diagram illustrating the locker software architecture.

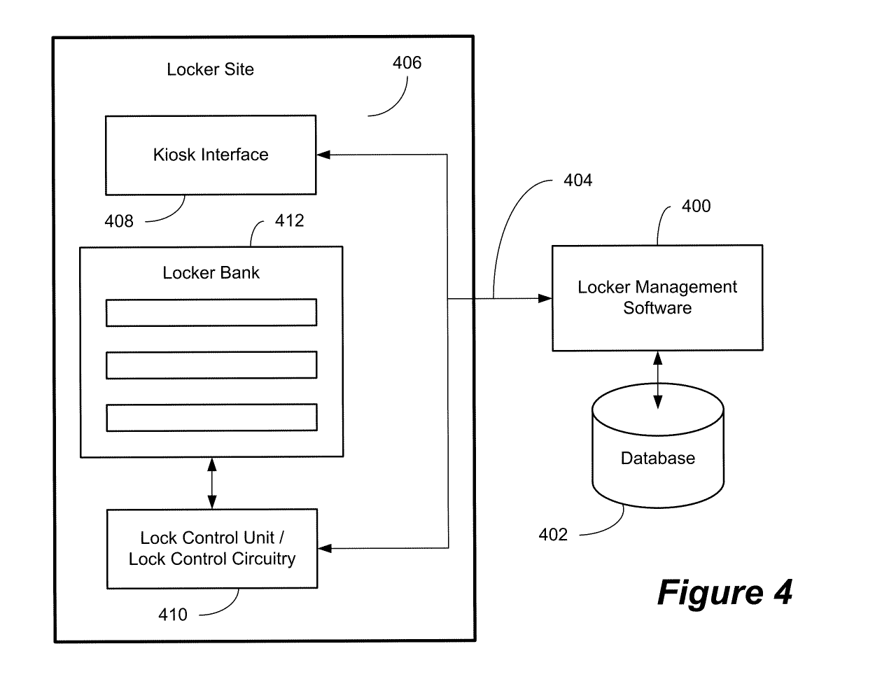

FIG. 4 is a block diagram illustrating a networked, cloud based locker solution.

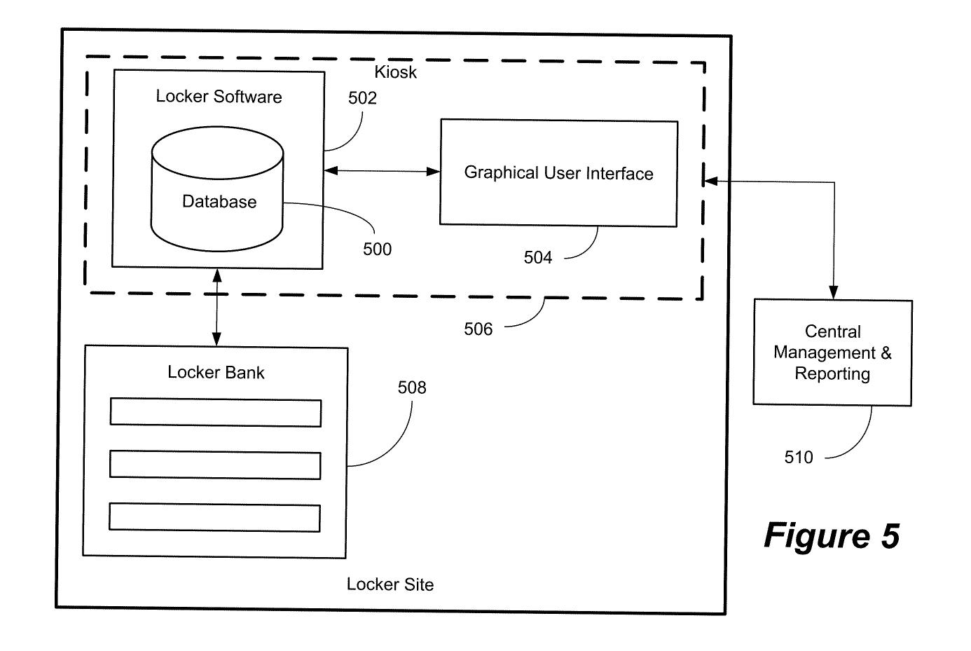

FIG. 5 is a block diagram illustrating a stand-alone locker solution.

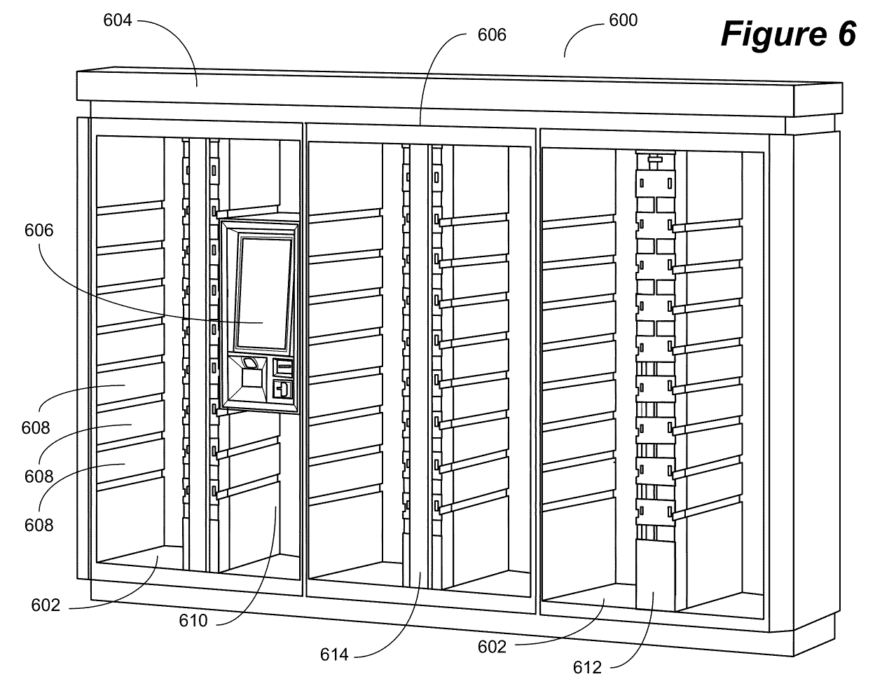

FIG. 6 is a perspective view of a locker bank associated with the reconfigurable locker system.

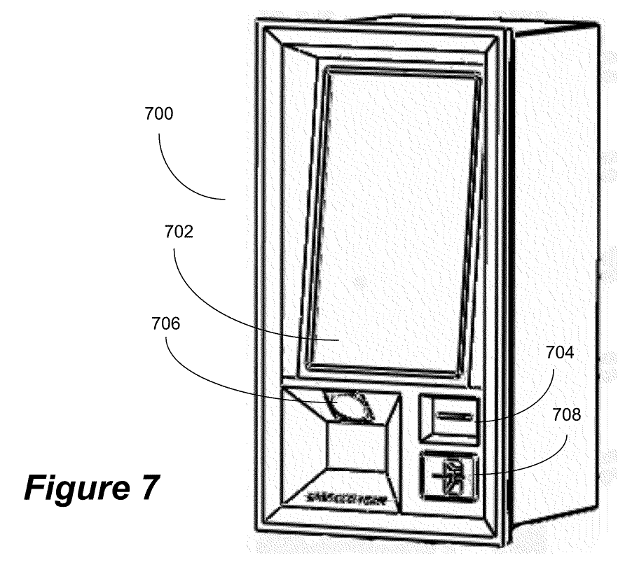

FIG. 7 is a perspective view of a locker cabinet kiosk.

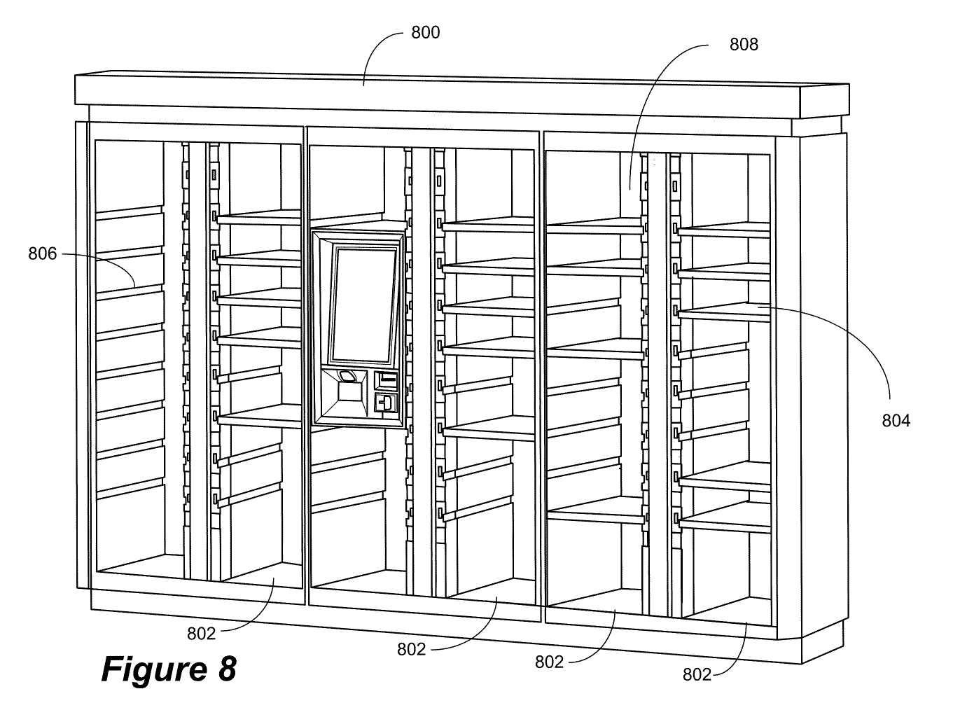

FIG. 8 is a perspective view of a locker bank associated with the reconfigurable locker system with some of the shelves shown removed so that a locker operator can reconfigure the locker sizes.

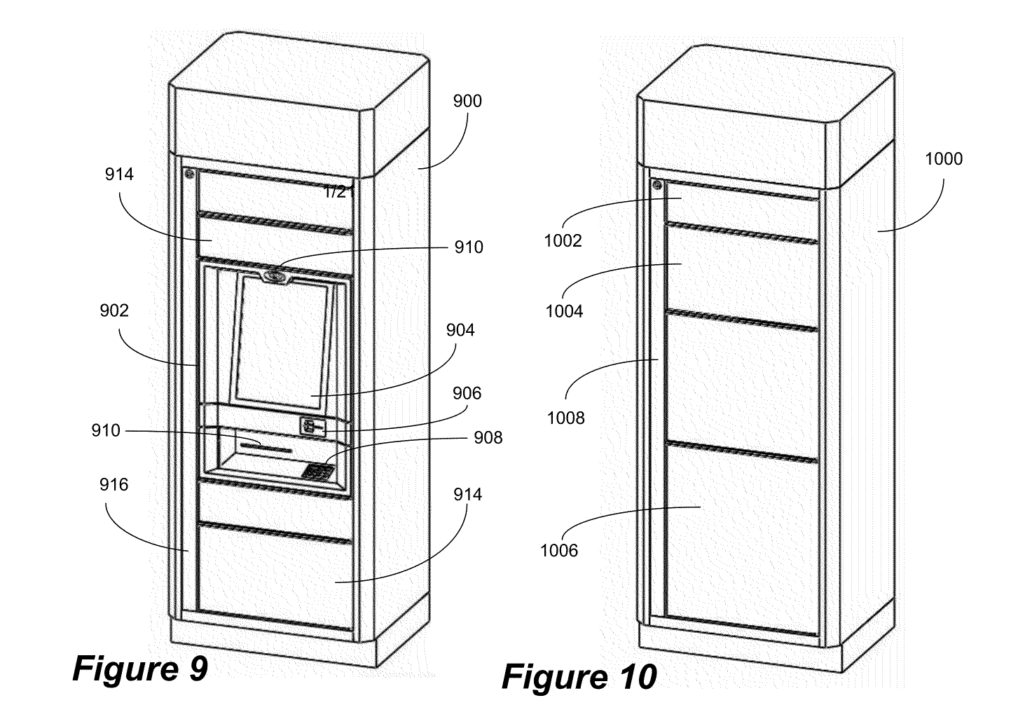

FIG. 9 is a perspective view of a locker cabinet with a kiosk.

FIG. 10 is a perspective view of a locker cabinet with individually addressed lockers for holding packages.

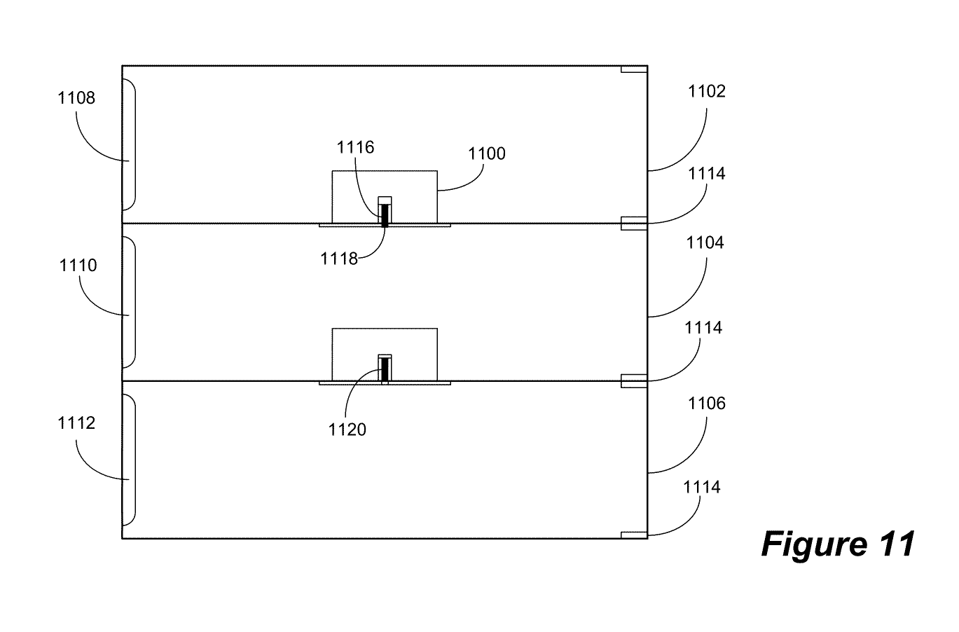

FIG. 11 is a rear view of a plurality of locker doors having a locker door interconnect mechanism linking multiple doors together so that they function as one door.

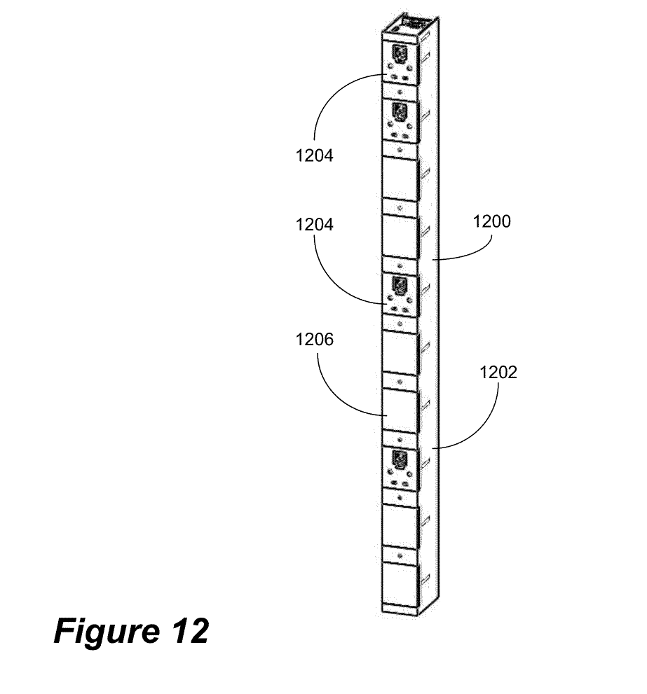

FIG. 12 is a perspective view of a locker control column holding locker control modules and empty bays.

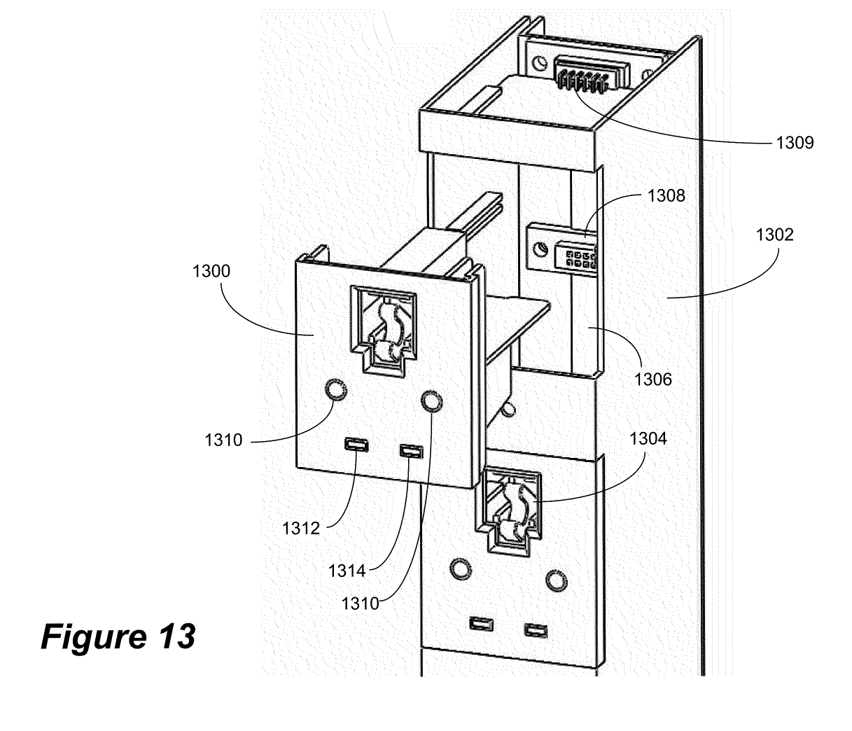

FIG. 13 is a perspective view of a locker control column illustrating the removal or sliding out of a locker control module.

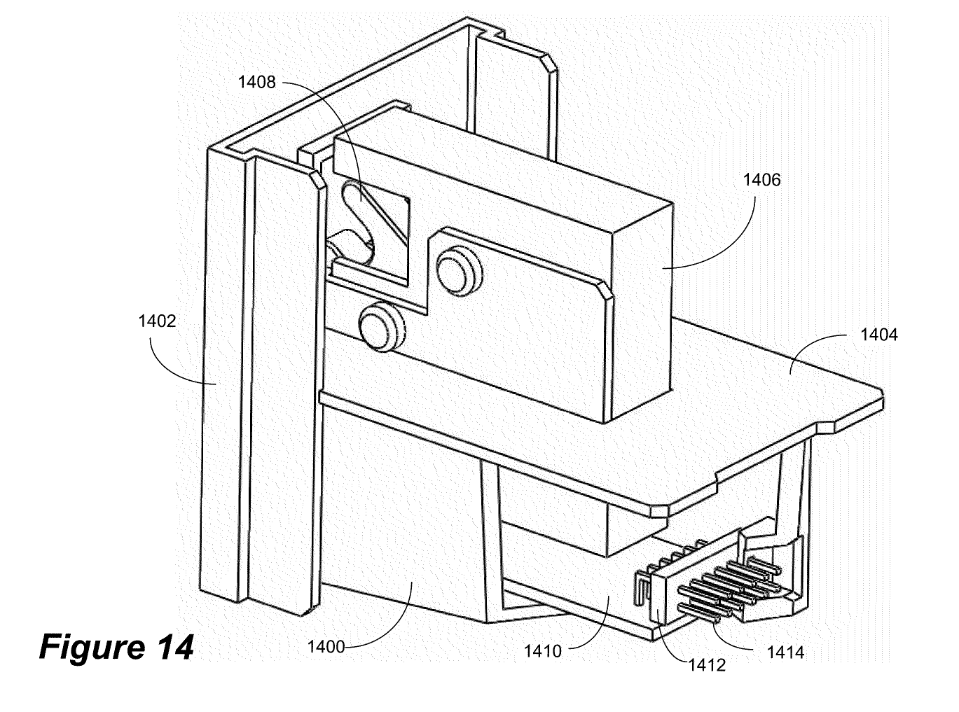

FIG. 14 is a rear perspective view of a locker control module.

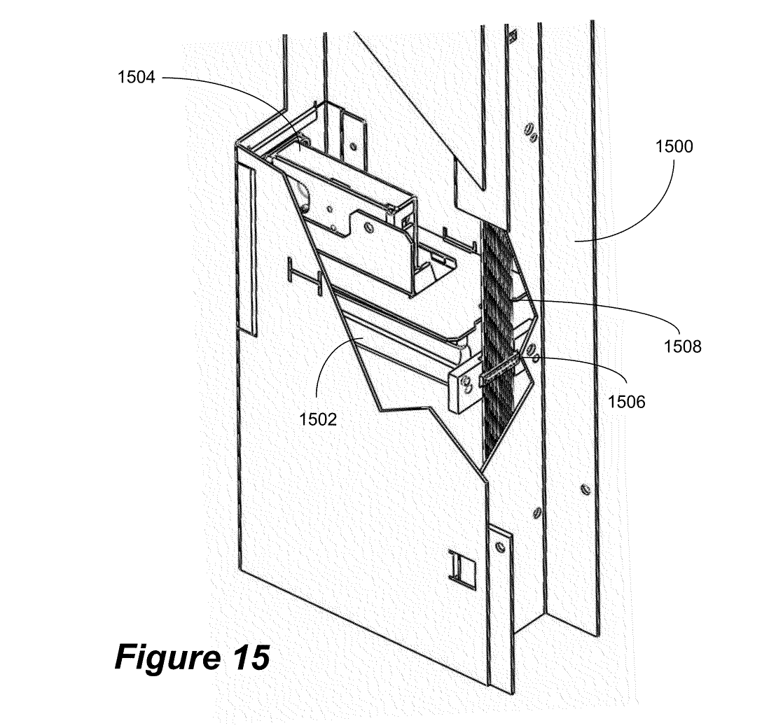

FIG. 15 is a rear perspective view with a cut away of the interior of the locker control module connected to a wire ribbon that provides power and a communication pathway between the lock mechanism and the locker control system.

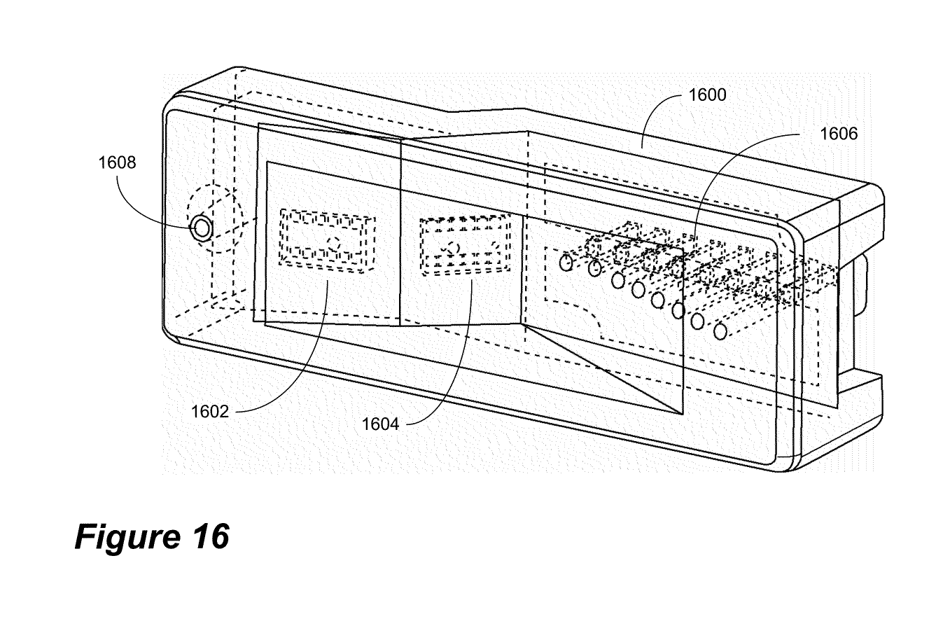

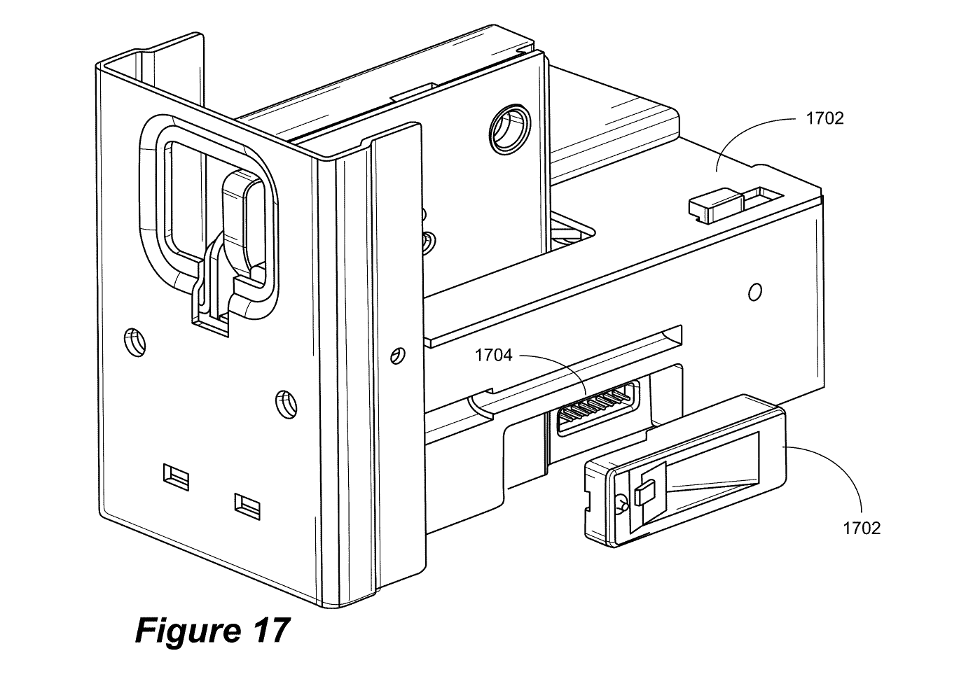

FIG. 16 is a perspective view of an optical sensor capable of detecting items within a locker.

FIG. 17 is a perspective view of an optical sensor modularly plugging into a locker control module.

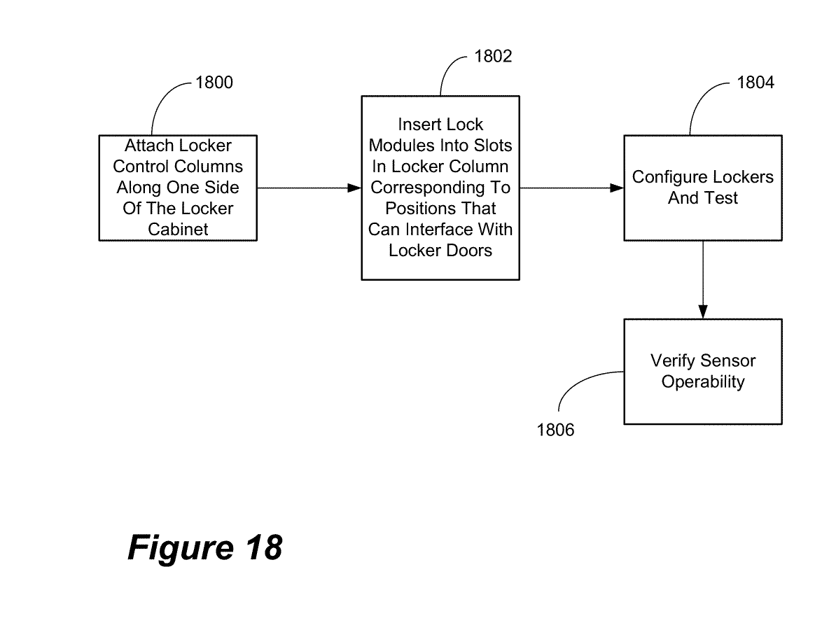

FIG. 18 is a flow chart illustrating the installation of the locker control column and locker control modules in the locker cabinet.

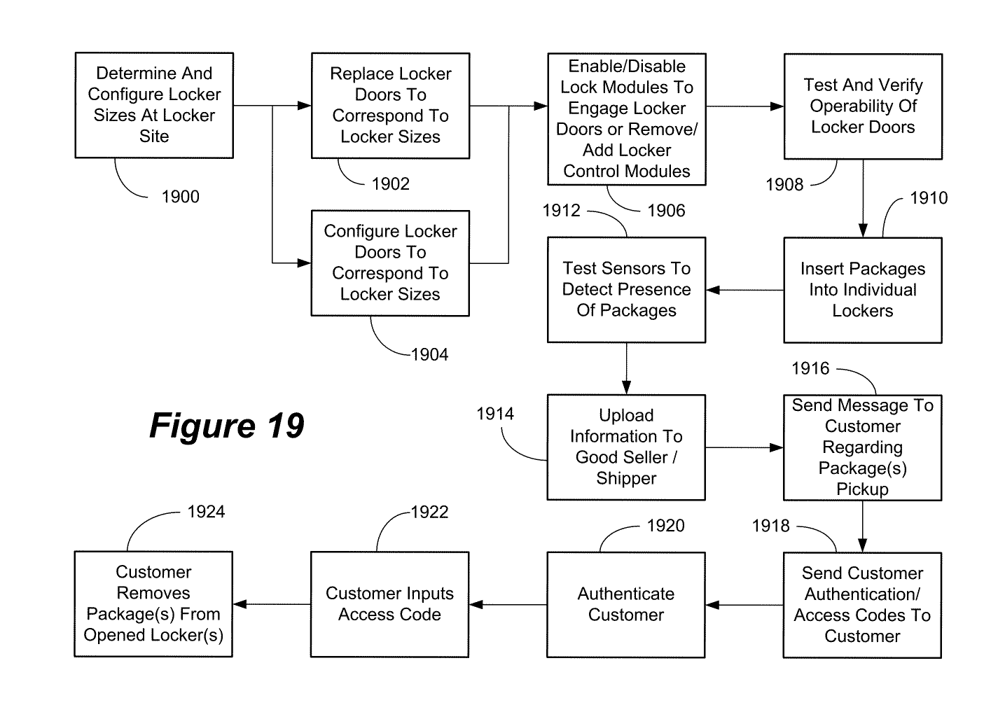

FIG. 19 is a flow chart illustrating the configuration of the locker doors and shipping packages to a locker site for customer pickup.

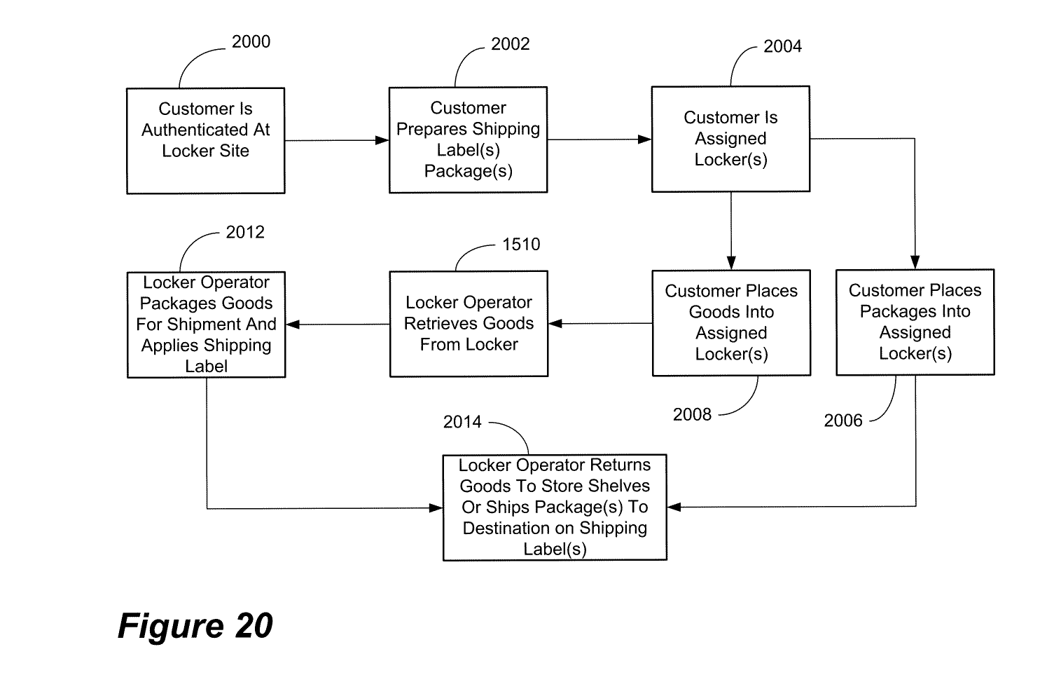

FIG. 20 is a flow chart illustrating the shipment of goods or packages to a customer desired location.

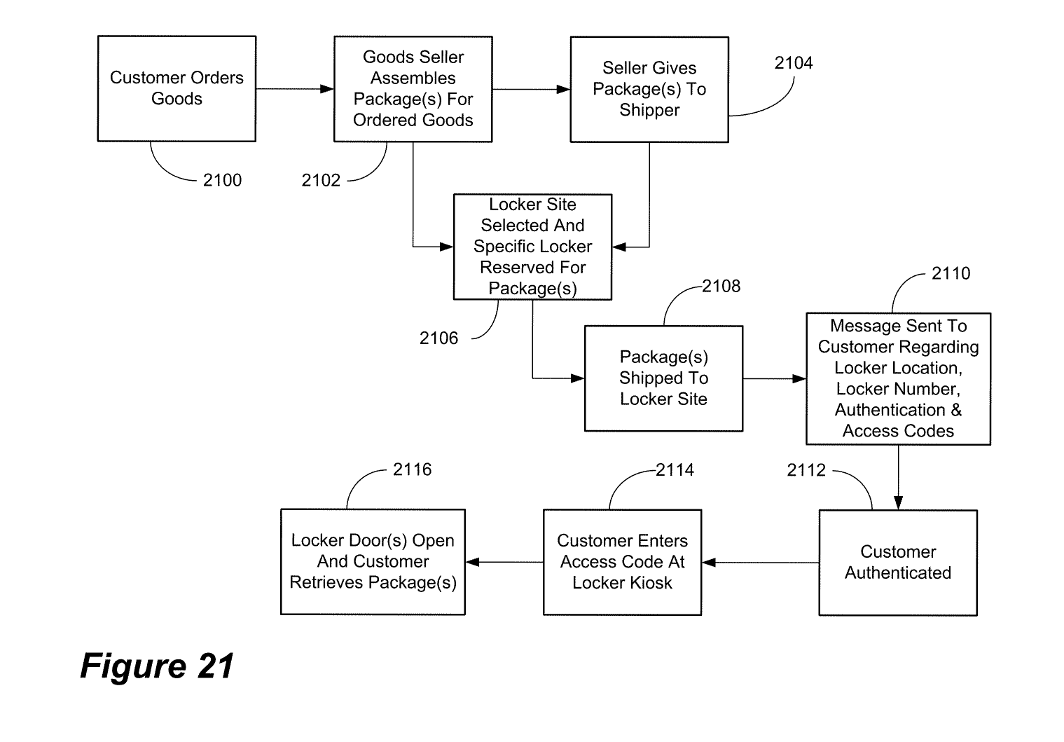

FIG. 21 is a flow chart illustrating the shipment of goods by a seller or package shipper to a locker location for customer pickup.

### DETAILED DESCRIPTION

The increase in e-commerce activity is driving e-commerce goods suppliers to provide same day delivery service. These e-commerce providers are increasingly encouraging shippers to assist in same day goods delivery, engaging third parties to play this role or taking on the challenges of same day delivery by the e-commerce companies to enter the transportation business themselves with a new perspective on the e-commerce goods delivery business model. One way to enter into this business is for e-commerce goods sellers to take over the transportation aspects and ensure delivery of goods into the late evening or early morning hours or even into the weekends—essentially the e-commerce goods sellers are demanding delivery times during periods in which current shippers' business models do not support. The battle for the last mile or last several miles is a challenge that will increasingly force goods shippers to change their business models or will allow e-commerce goods sellers opportunities to exploit the shortcomings of the shippers delivering goods to customer's homes at times when the customers are actually home to receive the goods and not at work.

An alternative to the challenges of the delivery of goods the last mile to individual businesses and homes is creation of a delivery system where goods are delivered to lockers that are positioned in places that are near a customer's work, recreation area or home. Thus, the proverbial “last mile” is the responsibility of the customer and not the e-commerce goods deliverer or shipper. Such a scenario would substantially reduce the transportation costs to the e-commerce goods seller.

For e-commerce providers who also operate traditional retail brick and mortar locations, the lockers could be located inside or outside the retail location allowing the customers to pick up goods after the business hours of the retail establishment. Also, the retail clerks could function as the locker operator where the order goods may be already in the retail establishment's inventory or could be delivered as a part of the daily replenishment of the inventory of the retail store. Other locker system locations could include shopping malls, a commuter bus stops or train stations, office buildings, strip malls, etc.

FIG. 1 is a block diagram illustrating the communication pathways between a locker system having a kiosk and the customer. When goods are ordered by a customer 100 online via the internet 102 or by a mobile device 104, the purchased goods can be shipped to a locker location 106 selected by the e-commerce goods seller 108 or selected by the customer when the order was placed by the internet 100 or by the customer's mobile device 104 across a cellular network 110 or across the internet.

Once a locker location is selected and the goods are shipped from a distribution hub they will arrive at the locker location 106. The e-commerce goods seller 108, the shipper or an intermediary may be the party who actually operates the lockers at the locker location. In one embodiment, the locker operator may configure the individual locker size to closely correspond to the size of the package(s) containing the goods that were ordered. In another embodiment, the locker size may be configured by the e-commerce goods seller. Software operating on the cloud 112 or on servers operated by the e-commerce goods seller can also automatically know that the goods ordered by the customer will be shipped in certain sized package(s) that require a particular locker size configuration. When the goods arrive at the locker location 106, the locker operator may already have instructions on how to configure the locker size for the ordered goods configured by the software operated by the e-commerce goods seller. The locker operator may even know which specific locker(s) are assigned to store the package(s) awaiting pick up by the customer automatically configured by the e-commerce goods seller software.

Once the package(s) are inserted in the locker, the e-commerce goods seller can detect if the locker operator has correctly placed the packaged goods ordered by the customer are correctly installed in the appropriate locker. Once the package(s) are placed in the locker the e-commerce goods seller, shipper or locker operator can send out the customer authentication code and the locker access code. In an alternative embodiment, the customer access code and customer authentication code can be sent to the customer when the confirmation of the goods are ordered and again when a message is sent to the customer informing them that the packaged goods are in a specific locker and are ready to be picked up by the customer.

Sensors located in the lockers can keep track when packages are inserted into the locker, the package(s) are picked up and/or if returns or other packages are dropped off by the customer for pick up. One of the advantages of this locker system is the ability to handle returns. If a customer seeks to return previously purchased goods, the customer can stop by the lockers, configure return labels at the kiosk and insert the goods for return to the e-commerce goods seller. If the customer does not have packaging for the return, the goods can be merely left in their original packaging and the locker operator can package the goods up for return to the e-commerce goods seller.

The lockers could function with the customer using the kiosk 114 to authenticate themselves and input their access code to open the locker door allowing the customer to retrieve their goods or packages. In one embodiment, the locker control software is not located on the cloud 112, but instead the locker functionality is run from the kiosk 114 at the locker location 106. With the installation of an app on the customer's mobile device 104, the mobile device 104 can be communicated directly with the kiosk 114. The kiosk 114 may comprise a wireless interface into the cellular network or the Internet. Such a direct connection could allow the customer to bypass the e-commerce goods seller or even the shipper. The customer access and authentication codes would be generated by the kiosk 114 and transmitted directly to the customer once the package(s) are placed in the locker.

The locker system 106 could also function autonomously. This could occur when the communications channels 114 and 116 between the locker system 106 and the cloud are down. In such a scenario, the customer could authenticate themselves and input the locker access code based on information that is stored locally in memory in the kiosk 114 of if the kiosk 114 is not present at a particular locker location, the customer authentication and locker access code could be stored in a memory location accessible by a processor that is controlling the locker control modules.

FIG. 2 is a block diagram illustrating the communication pathways between the locker system 200 and the customer's mobile device 202. In this embodiment, the locker system 200 does not have a kiosk and the locker system intelligence is located in the cloud 204 and the locker system 200 can be operated without a kiosk. In this embodiment, the customer orders goods via a computer 206 on the internet 208 or by a mobile device 202 on a cellular network 210. Even though there is not a kiosk, the customer could use a downloadable app on their mobile device to interact with the locker system so that the mobile device could connect via a local connection 212 that could connect the customer's mobile device 202 with the locker system 200 by a Bluetooth communication protocol wireless connection, a WiFi connection or some other wireless protocol that could connect the customer's mobile device 202 directly with the locker system 200. In an alternative embodiment, the customer's mobile device could connect 214 to the cellular network and then on to the locker system 200 or connect 216 to the internet and then on to the locker system 200. In all of these connections 212, 214 or 216, the app running on the mobile device 202 could authenticate the customer and when the correct access code is entered by the customer, the locker door would open allowing the customer to retrieve their packages or goods.

Once the customer orders goods from the e-commerce goods seller 212, the e-commerce goods seller 212 allocates the goods from their distribution hub for transportation to a locker 200 selected by the customer or allocated by the e-commerce goods seller 212. The goods are transported to the lockers 200 and the locker operator configures the locker size optimized for the best fit size of the customer's packages. When the e-commerce goods seller 212 receives the customer's order, the size of the package is automatically configured to the most efficient shipment of the ordered goods (e.g. goods in stock can be arranged in the same shipping package or sent in separate packages if pre-determined by the e-commerce goods seller to be more optimal to the cost of shipping the goods from the distribution hub to the locker location.

Before the package(s) arrive at the locker location 200 or once they arrive at the locker location 200, a specific locker or set of lockers may be assigned to the package(s). Text, email or an automated call may be sent to the customer alerting the customer that the package(s) have arrived and are ready for pick up. Customer authentication and access codes may also be sent to the customer's mobile device. Once the customer arrives at the locker location 200, the customer can be authenticated and the access code can allow the locker operator 200 to enable the locker control module(s) securing the locker door(s) to open thus allowing the customer to retrieve their package(s). Once a sensor detects that that package(s) have been removed, the locker operator can re-enable the locker control module thus re-locking the locker door.

If a customer seeks to return previously purchased goods, the customer can use their mobile device to send a return merchandise authorization (“RMA”) request to the e-commerce goods seller 212. The customer can identify the returned goods and the locker system can open an empty locker that is already configured for the appropriate size of the package(s) that best fits the size of the goods being returned. The locker will typically not be capable of reconfiguration by the customer in such a scenario. In other words, the customer will not have the ability to remove lockers shelves or reconfigure the lockers to conform to the goods being returned. Once the goods to be returned are placed in the locker, the sensor can detect the goods and the locker operator or e-commerce goods seller can re-enable the locking of the locker door thus securing the goods subject to the RMA until they can be picked up.

In such a configuration, a kiosk may or may not be present and the interaction between the customer and the e-commerce goods seller can be conducted via the customer's mobile device and automated cloud based software making the pickup of order goods and the return of any goods seamless and automated. If customer service is required, the customer can interface with the e-commerce goods seller's customer service agent by phone to resolve any issues. If a kiosk is involved with a locker system as previously described in FIG. 6, the customer may have a video conference with the e-commerce customer service representative.

Once the package(s) are detected in the locker by the sensor(s) and the locker door is locked, the e-commerce goods seller, the shipper of the goods/packages or the locker operator can enable a message to be sent to the customer letting them know that their goods/package(s) are at a specific location, assigned to a specific locker or set of lockers if there are a number of packages and the access code. Once the ordered goods are delivered to the locker location, the e-commerce goods seller or the shipper can send an email, text, automated call letting the customer know that the goods are ready to be picked up. Included in the message(s) sent to the customer, the locker system or cloud based locker control system can send information about the locker location, locker number, customer authentication code and access pass code.

When the customer who ordered the goods arrives at the locker location, the customer can access the locker by entering the pass code, locker number and/or authentication information. Once the package(s) are removed, sensors in the locker can detect whether all the packages were removed or whether some object, package or letter was left behind. The locker system can then relock the locker until additional package(s) are inserted into the locker and assign the locker to a new customer.

The kiosk may also be networked to the Internet or on a communication network so that the locker location may be connected to a centralized locker access control station located on premises or in the cloud. The centralized locker access control system could connect a plurality of locker locations and help facilitate the selection of a locker location in close proximity to a customer's home or work location easing the inconveniences of the purchased goods pickup by the customer. The locker control unit location could also receive date and time information recording the activities of the locker door for reporting to the centralized access control station. The locker control module can retain the activity log in memory for reporting even if the central microprocessor is not available because of a network failure or similar event.

A locker operator (the e-commerce goods seller, shipper or a third party) assigns a locker and has the customer's packages inserted into the selected locker. Locker access codes and customer authentication could then be sent to the customer's mobile device. When the customer arrives at the locker location, the customer uses their mobile device to authenticate themselves and open the locker with their access code by transmitting the locker access code and authentication information over the internet or a cellular network to the locker operator's locker management control software which would then unlock the locker from a remote location of from the cloud.

Signals that control the locking and unlocking of the lockers is controlled by actions conducted by the locker operator, the retailer or the e-commerce goods seller. The locker operator may or may not be controlled by the e-commerce goods seller since some locker operators may be third parties in the locker business. Also, shippers may control the lockers. In any case, the locker operator may be one of these parties and will have responsibility for the physical configuration of the locker sizes.

Such a locker system configuration could further reduce the overall installation and operating costs of a locker system since the kiosk could be removed and the intelligence for locking and unlocking individual lockers could be controlled by controllers or microprocessors connected to the locker control modules and a communication network (wired or wireless network) connecting the locker bank to a centralized control center operated by the e-commerce good seller, the shipper or a third party. Access and authentication codes could be sent over a communication network to customer's mobile device so that when the customer arrives at the locker bank the customer can input the access code, be authenticated by the locker operator and the locker operator can send signals allowing the locker(s) to open so that the customer can retrieve their package(s).

FIG. 3 is a block diagram illustrating the locker software architecture. Firmware operating on the lock control module 300 can control the locking and unlocking of each locker in the locker bank. The lock control module firmware may be capable of interacting with software that operates the kiosk and provides the input/output interactions with customers. In other embodiments, the firmware operating on the lock control module 300 can communicate directly with a cloud framework 302 supported by a communication's protocol allowing the lock control module 300 to communicate with the cloud framework 302 operating in the cloud.

The cloud framework 302 may interact with the locker application 304 that may run either on the cloud or on the e-commerce goods seller, shipper and/or locker operator 306. A locker dashboard 308 can provide real-time data as well as trends, errors or potential problems to the e-commerce goods seller, shipper and/or the locker operator. A customer app 310 may be downloadable for customers to also provide updates on the status of a customer's order, including the status of the packages in route from the distribution hub to the locker.

FIG. 4 is a block diagram illustrating a networked, cloud based locker solution. In a cloud based locker management system, locker management software 400 and access to at least one database 402 may be located on the cloud. The cloud based software and database may communicate via a network 404 to a locker site 406. The cloud based software may interface with the kiosk graphical user interface 408 and the embedded locker control unit that may be associated with a lock control unit and lock control circuitry 410. The embedded locker control unit can engage with each lock associated with each locker 412 and control the unlocking of the locker for package retrieval.

FIG. 5 is a block diagram illustrating a stand-alone locker solution. Locker system logic or software may be employed and enabled by the locker operator to operate the locker system. A database 500 may be accessible by the locker software 502 and coupled to a customer graphical user interface 504. In an alternative embodiment, the database 500 may be located on the cloud.

The computing software may be located in the kiosk 506 or in another location that facilitates proper functioning of the locker system. The locker software can provide authentication of the customers and support the entry of access codes, among other tasks, so that customers can enter their access codes, the locker doors will unlock and the customer can retrieve their packages from locker(s) in the locker bank 508. A centralized management and reporting function may be enabled by having the locker software communicate via a wired or wireless network to a goods seller or package shipper 510.

FIG. 6 is a perspective view of a locker system 600. The lockers may be arranged in a locker cabinet 602 comprising a plurality of lockers stacked on top of each other. A plurality of locker cabinets 602 may comprise a bank of lockers 604 thus forming the locker system 600 where the locker system 600 comprises at least one locker cabinet 602 along with at least one kiosk 606. The locker cabinet 602 may comprise standard locker sizes 608 or a locker size that varies with different spacing heights between the shelves of the individual lockers.

Typically, lockers are constructed of sheet metal that is formed and either welded or secured in such a way that the lockers are not easily accessible between each other. In prior art lockers, the locker size itself is fixed. In this invention, the locker area may be configured such that a locker operator can add or remove shelves thus configuring the optimal size of a locker for storing goods for later pickup.

In one locker system 600 configuration, the kiosk 606 may occupy part or all of a locker cabinet 602. For example, the kiosk 606 may occupy the upper part of the locker cabinet 602 and the locker areas 610 located below the kiosk 606 may be converted into lockers or drawers that hold supplies for the locker system 600. In other configurations, the kiosk 606 may be located separate and apart from the locker bank 304.

The kiosk 606 may comprise intelligent functionality that may include input output devices. Some of the kiosk's functionality may be implemented by a kiosk control module (not shown) that comprises a microprocessor and circuit board that can functionally communicate with other input/output devices.

In some configurations, multiple locker banks 604 may be located in a linear fashion along a wall or in parallel rows such that the kiosk controls just the lockers in one locker bank 604 (e.g. one kiosk 606 assigned to control each locker bank 604) or the kiosk 606 may be configured to control all the lockers in a plurality of locker banks 604. As a practical matter, the kiosk 606 is limited in the number of total lockers it can support based on a variety of factors that include problems with coping with security of the goods when a customer unlocks the locker storing their goods only to have a third party interloper steal the goods in between the time it takes for the customer to unlock the locker and walk to the locker to retrieve the stored goods; the amount of traffic in the locker storage bank area; and queuing time waiting to gain access to the kiosk 606.

The locker bank 604 comprises at least one locker control column 612 that provides the control mechanisms for locking (not shown) and unlocking specific locker doors (not shown). The locker control column 612 may be secured by a removable panel or stile 614. Once removed, the stile 614 can allow the locker control modules (not shown) to be removed, repositioned and/or replaced. The locker control modules are configured so that they are in electronic communication with the kiosk 606 and can engage with the locker door to secure the locker. Stile 1008 may be secured by screws or a lock mechanism so that when the stile 1008 is removed, a locker operator can gain access to the locker control column 612 and the locker control modules that are in the locker control column 612.

FIG. 7 is a perspective view of the kiosk 700. The kiosk 700 may comprise an internal kiosk control module that comprises a computer or processor capable of processing data and that enables or disables certain functional aspects of the locker system. The kiosk 700 may comprise a screen 702 for receiving and/or sending commands and information as a customer or locker operator interacts with the locker system, a customer identification card reader 704, a scanner 706, a printer output port 408, and a camera (not shown). Drawers located above or below the kiosk 700 may hold supplies such as shipping labels, printer paper, shipping envelopes, and small folded boxes for use as packaging for the shipment of goods.

In one embodiment, a computer may be used to connect various input/output devices as well as connect by a communication pathway to the Internet/cloud for sending and receiving instructions or other information such as data regarding the operation of the locker system. Such input/output devices may include a screen 702 may be of any size and may support an actual key pad or a virtual key pad as well as support video chats between a locker customer/user and a customer/support technicians.

Other input/output devices may include a camera, microphone, and loudspeaker to support interactions with customer service, technical support or to provide photographic evidence of the person who inputs the access codes that will open the locker releasing the goods. Input devices may include a number only keypad, a key board, an ADA keypad, a bar code scanner, a card reader 704 can be used to authenticate customers by allowing customers to insert their driver licenses, passports, credit cards, smart card or some other form of customer authentication to verify that the person accessing the locker is authorized to take the goods. The kiosk 700 may also support printer connected to a printer output port 708 for printing out receipts, shipping labels or other messages.

Networking the kiosk 700 to the Internet or cloud may involve a variety of communication equipment that is well known in the networking art. By enabling communication via networking, the locker system may store data on the cloud, may support manufacturers, distributors, retailers, dealers or shipping companies efforts to manage the flow of goods in the distribution chain to enable same day delivery of ordered goods.

The kiosk 700 may also employ a key pad for inserting customer access codes for use by customers to gain access to specific lockers. An alternative embodiment may include a scan reader 404 that can read bar codes, QR codes, or an access code directly from the customer's mobile device screen. Another alternative embodiment may support verifying the customer by a wireless message sent from the customer's mobile device directly to the kiosk 700 or by a wireless message sent over a communications network to the kiosk 700.

Each addressable locker control module may be connected to at least one lock engine which serves to identify the locker control module with a specific locker opening enabling control by the locker control unit. One or more configuration switches on the locker control module may be used to assign a particular locker control module to a particular locker. When adding a locker control module, changing the location of a locker control module or removing one from service, the switch can be activated and the locker control module will notify the central microprocessor to add or remove the locker control module and associated locker control module from active service.

Alternatively, each locker control module may be uniquely addressed with a silicon serial number that is programmed into the memory (e.g. MAC addresses), either at the time production of the microprocessor or during the time of manufacturing of the lock control unit, or during the time of installation of the locker system. For example, a scanner can be utilized to scan an addressable number from the locker control module or lock device by attaching a bar code, QR code or some other readily identifiable number or code along with the locker number and the locker size for input to the database, providing sufficient information to enable the locker management database to maintain a map of the locker configuration. Alternatively, the addressable number could be entered into the locker control unit by a series of keystrokes taken from a label on the lock control module.

The locker control module can have an input LCM address mapped to the locker control unit mapping the physical location of the locker control module with the locker cabinet and locker bank. With such an addressing system tied to the locker control modules, the locker management software can keep track of locker configuration sizes, locker maintenance issues and other issues related to the effective operation of the reconfigurable locker system.

A camera may be configured with the kiosk 700 so that customers or users can interface with customer or technical support personnel who are located remotely from the locker system. The camera may also be configured to capture images of each user who interacts with the kiosk 700 so that images of the user may be used if fraudulent or criminal activity involving the locker system is discovered.

FIG. 8 is a perspective view of a locker bank 800 comprising a plurality of locker cabinets 802 that can be configured with removable shelves 804. Here, the locker cabinets 802 include the actual locker space typically constructed of sheet metal or a high strength plastic material such as ABS, polycarbonate or high density ethylene plastic materials. Recessed edges 806 can be configured to accept the removable shelves 804. The removable shelves 804 form the floor and ceiling members 808 of an individual locker space. The locker bank 800 may be configured so that the rear panel 808 may be removable and the locker shelves configured from the rear of the locker bank 800. In such a configuration, the locker operator could open the rear of the locker bank 800, reconfigure the locker shelves 804, connect or disconnect the locker doors together so that the locker door conforms to the size of the newly created locker size, and then re-program the locker control unit so that the locker system knows which locker control module (s) to take offline or put online for the newly configured locker. Once the packages are placed in the locker(s), the rear panel 808 could be closed and secured by the locker operator.

In another configuration, an online merchant or a package shipper can configure its shipping locker sizes to conform to their standardized package dimension sizes. Thus, when customers place orders with the online merchant or a shipper is selected, the online merchant/shipper can calculate the optimal sized shipping packaging and the size of the locker that will be required once the package arrives at the locker location. This locker size information can be sent to the locker location shortly before or at the time the package arrives so that the locker operator can configure the locker size to optimally confirm to the package size. This optimization can ensure that the locker bank utilization is not wasted by the selection of a poor configuration that wastes space and allows the locker bank to maximize the number of packages that can be stored in a given location.

Diagnostic software can monitor the individual locker utilization at a locker bank and make recommendations to the locker operator on how to better utilize the existing locker configuration so that the optimal number of the appropriate sized lockers is implemented at a particular locker location. The software operating on the locker control unit or operating remotely on the cloud can predict future demand by analyzing historical trends as well as anticipated needs in the coming days or weeks. These recommendations for locker configuration and reconfiguration will to improve locker utilization rates by allowing locker operators to configure the lockers according to current or anticipated demand.

FIG. 9 illustrates a modular locker cabinet 900 with an integrated kiosk 902. The kiosk 902 can comprise a display screen (e.g. a touch screen display) 904, a card reader 906, a key pad 908 a camera 910, a microphone and loudspeaker (not shown), a bar code, QR code or other scanner capable of reading and registering information and a printer output port 912. Located above and below the kiosk 902 may be storage areas 914. Behind stile 916 is located a locker control column having at least one locker control module assuming that the locker cabinet 900 shown in FIG. 9 has a locker space configured. The modular locker cabinet 900 with the integrated kiosk or a separate and detached kiosk (not shown) can be coupled with a plurality of modular locker cabinets to form a locker bank.

The kiosk 902 housed with the modular locker cabinet 900 may be shipped separate of other locker cabinets 1000 so that if a kiosk fails, a kiosk modular locker cabinet 900 can be shipped to the location where the failure occurred. The kiosk 902 may use a graphical user interface to allow locker operators to selectively control access to individual locker(s). The central locker control unit may allow for the opening and closing of the lockers, either individually or in adjacent groups of locker doors.

To support large volumes of packages, additional locker cabinets can be added in a side-by-side configuration to form a bank of lockers comprising at least one or a plurality of locker cabinets. In large scale facilities a plurality of locker cabinets can be assembled to form locker bank(s) whose size depends upon the size of the facility holding the lockers and the anticipated traffic of customers. Limitations as to the number of lockers that can be grouped together in a locker complex are the site-specific location parameters.

Electronically, there is no limit as to the number of lockers that could be supported by one kiosk or one kiosk control module. However, from a practical perspective, a locker operator would not want long lines to form as users arrive to input their access codes and access their locker contents. As an alternative embodiment, the kiosk does not have to be located on or in a locker cabinet. Instead, the kiosk may be located in a stand-alone position near the locker cabinet or locker bank instead of being integrated into a locker cabinet.

In one deployment embodiment, a locker cabinet may comprise one or more locker openings depending on the mix of openings between the various sizes being considered. For example, a locker cabinet could support a mix of very small letter size, small, medium, large and jumbo locker opening sizes. It is currently anticipated that the jumbo size would extend from the floor of the bottom of the locker cabinet to the top of the top locker of the locker cabinet. Thus, the configuration of the individual lockers can change from one installation to the next.

A locker bank could be configured with a plurality of locker cabinets 900 and 1000. The locker bank could have the plurality of locker cabinets positioned side by side with several locker cabinets 1000 associated with a locker cabinet having a kiosk 900. Because of the plug and play ability of the modular locker system, these locker cabinets 900 and 1000 can be connected by a cable that would supply power and/or communicate information over the cable. In an alternative embodiment, the power could be supplied by the cable and the data or commands carried by wireless channel(s). As conditions change at a particular locker system location, locker cabinets 900 and 1000 could be added or removed based on the volume of traffic, including the addition of locker cabinets 900 and 1000 during times of large holiday shopping and removed once the holiday shopping period ends.

FIG. 10 illustrates a modular locker cabinet 1000 that when coupled with other modular locker cabinets can form a locker bank as shown in FIG. 8. Each of these locker cabinets 1000 can be configured so that the individual locker sizes may change. For example, the locker cabinet 1000 comprises a small locker 1002, a medium sized locker 1004, to a larger locker size 1006. To increase or decrease the size of a locker, the locker operator can open the locker door located above and below the locker shelf and remove the shelf in order to make a locker size larger or if the locker operator seeks to create two locker areas within one locker space, a shelf may be inserted to divide a larger locker space into two or more smaller locker sizes.

When the locker size is changed by the insertion or removal of a locker shelf, the locker door size is impacted and may need to be reconfigured. There are several ways to handle the proper sizing of the locker door when the actual locker is resized by the insertion or removal of locker shelves. The simplest solution is for the locker operator to replace the locker door with one that is sized for the new locker dimensions. If the locker sizes are standardized, this would minimize the total number of locker doors that the locker operator would need to have in storage.

Inside the kiosk of FIG. 9 or even within the locker cabinet illustrated in FIG. 10 that may not have a kiosk, the locker doors can be controlled by a locker control unit (not shown). The locker control unit may comprise an off the shelf Linux computer that controls the locker doors and processes the locker configuration, the input of customer authentication and access codes allowing the customer access to packages or goods in the locker. The locker control unit may have a serial port containing cable plugs connecting the locker control columns with the locker control unit. The locker control unit may also operate all the lockers and may also connect to software and databases located on the cloud. If a kiosk is present, the locker control unit could run the graphical user interface of the kiosk and interact with customers at the locker bank. The customer could also interact with the locker system via their mobile device interacting directly with the locker system, via the cloud and apps running on the customer's mobile device.

An alternative solution to removing and resizing the locker doors is shown in FIG. 11 where the locker doors themselves can have a locker door latching mechanism 1100 so that two or more locker doors may be attached together to form one locker door. In FIG. 11, locker doors 1102, 1104 and 1106 have handles 1108, 1110 and 1112, respectively, integrated into or formed into the individual locker doors. The locker doors 1102, 1104 and 1106 are also individually hinged 1114. The locker door latching mechanism 1100 may be constructed with a simple, manual pin interconnect 1116. When the pin interconnect 1116 is engaged 1118 with the locker door 1104, locker doors 1102 and 1104 can act as one door. When the pin interconnect 1116 is not engaged 1120, locker doors 1102 and 1104 can open and close separately.

In another embodiment, when the locker size is reconfigured and one or more shelves are removed, the locker doors associated with the new locker interior size may be connected via a strip that may be slipped between the locker doors that are going to be linked together to form an integrated door from multiple doors. In one such configuration, the strip may be in the shape of an I-beam that would be positioned on the outer and inner edges of the doors such that the I-beam could be slipped into the space area of the I-beam running parallel to the door edges.

In an alternative embodiment, the latch mechanism may be automated such that the latching and unlatching is controlled by the kiosk. Thus, the latch mechanisms control all the locker doors. When a locker shelf is removed, the new locker size may involve two lock mechanisms opening two locker doors. Likewise, if additional shelves are removed additional locker control modules may be disengaged so that multiple locker doors can open at one time. However, if more than two locker doors are opened, it may be advantageous to enable the locker doors to open as one unit as illustrated in FIG. 6. In addition, sensors connected to the locker control unit may be included into the shelf slot so that the locker control unit can detect whether a shelf is present in a slot thus known the exact locker configuration for any particular locker cabinet based on more than just the enabling or disabling of the locker control modules.

Another solution for coupling the locker doors together is to control their opening and locking electronically. When a package arrives at the locker bank, the locker operator can determine the optimal or best size of the locker by removing or inserting the proper number of shelves so that the locker bank utilization is optimized. Once the locker size is chosen, the package can be inserted and the locker doors closed. The locker operator can then electronically configure so that the correct number of locker doors open by the appropriate number of locker control module for the size of the locker used to store the packages. When the customer arrives to pick up their packages, the customer is authenticated and the locker control modules corresponding to the size of the locker that was configured to hold the package(s) are unlocked and multiple locker doors may open for easy removal by the customer of the package(s).

For example, an electronics retailer or pharmacy may have a need for more small sized openings while a home center store may have a need for more large and jumbo openings. Delivery firms often offer a preset size of containers they provide to their customers for shipping items and configuration of the locker sizes can be made to match the sizes of the containers. It is also anticipated that as the operator of a locker system utilizes the system over a period of time the operator will be able to analyze the customer usage and identify the optimal mix of locker sizes for their location. For example, in a business district there may be a need for more small lockers for letters while in a rural area there may be a need for larger packages.

Employing a locker system in a pharmacy or for use in the delivery of pharmaceuticals could provide a high level of security for the pharmacy. Once the prescription is filled, the medication could be placed in the locker and access and authentication codes sent to the customer. When the customer arrives at the locker location, they could sign for the medication at the kiosk or on their mobile device by engaging the locker system app. Once the customer is authenticated and agrees to the conditions of the medication (if a requirement of the medicine that is picked up), the customer would then be allowed access to the locker so they could retrieve the medications.

For convenience of the pharmacy, the rear of the locker may be opened so that the pharmacist can load the prescription medicines into the individual lockers without having to go to the front of the locker to open each individual locker door. In such a configuration, one embodiment may include a locker system having two doors for each locker—one controlled by the locker operator and the other controlled by the customer. Another configuration could include a large roll up door on the rear side of the locker controlled by the locker operator. In this case the locker operator would be the pharmacist.

To reconfigure an existing intelligent locker system to have a larger locker size, a technician would simply remove one of more shelves in one of the columns, remove the smaller doors and add a larger door of the appropriate size. The locker operator could remove the lock devices from the old positions and reinstall one in the appropriate position for the new larger locker with the larger locker door. The reverse process could be followed to convert larger lockers into smaller lockers. A shelf would be added, the large door would be removed and the appropriate number of smaller doors added. There would also be the need for one or more new lock devices and locker control modules to be added sufficient to match the increased number of lockers being created.

In the scenario where the number of openings was decreased, there would be no need for additional components other than the appropriate sized door. In the case where the number of openings is increased, only a corresponding number of new doors, shelves, lock devices and control modules would be required. No additional mechanical hardware is required such as door hinge points, lock device brackets or connectors for the control modules.

Once the lockers are mechanically reconfigured they could be reconfigured electronically in the locker control unit. The control unit comprises a microprocessor and a memory storage area. The microprocessor runs firmware that can access a database stored in the memory so that access control software can match the electronic network address of the lock control module and lock device with the associated locker. This association enables the software to monitor the status of the lock device and locker door configuration and have the capability to selectively unlock the locker for various functions including accepting packages, delivering packages and checking status of the electric lock device and the locker door.

FIG. 12 illustrates a locker control column 1200. The locker control column provides a modular feature that combines the logic for controlling the locks with a plug and play concept. A manufacturer may find it more cost effective to manufacture and ship the locker control column containing the intelligence aspects of the reconfigurable locker system allowing the construction of the actual locker system, e.g. construction of the sheet metal aspects of the locker system to be accomplished closer to the actual job site. By separating the construction of the locker control column from the construction of the actual lockers themselves, may allow for a manufacturer to win new business by cost effectively competition on the locker control column and allowing a more local manufacturer to construct and/or assemble the locker system while the locker control column manufacturer ships the locker control column separately to the job site.

The modular aspects of the locker control column 1200, which will become more evident upon review of the next several figures, support additional advantages of allowing an easier installation; a more robust electronic locker system; an electronic locker system that is substantially easier and more cost effective to install; easier reconfiguration and a substantially easier electronic locker system to trouble shoot and repair in the field. Prior art electronic lockers have separate, dedicated cables running from a kiosk to each individual electronic lock.

In one embodiment, the lock control modules are modularized and plug directly into a cable via a plug connection. The cable may run the length of the locker control column substantially simplifying connecting the locks with the kiosk. Additional cabling may be reduced by providing a wireless communication connection between the control circuitry controlling the lock mechanism in the locker control module and the kiosk having the man-machine interface.

In another embodiment, the lock mechanism may be separate or located separate of the lock control module. In such a configuration, the lock mechanism would be positioned to engage and disengage the locker door, but the lock control module would be located in another position other than within the lock mechanism's housing. The locker control module may be positioned in a locker control column arranged in vertical orientation so that the locker doors open on the right or the left. In another configuration, the locker control column may be arranged in a horizontal orientation so that the locker doors open from the top or bottom. The locker control module may also be located in a position separate and apart from the locker control module.

In one embodiment of the locker control column, the locker control column may comprise a housing further comprising front and rear side as well as a left and right side. The column may be constructed of several pieces or formed as a rectangular section of typically stamped sheet metal or high strength plastic. The rear side has a pin and connector interface mating the pins of the locker control module with the connector mating with a cable. In other embodiments, the connector could be mounted on the side, top or bottom of the locker control module. The specific location of the connector is somewhat dependent upon the modular structure and plug and play nature of the locker control module relative to the lock column and the locker control module relative to the lock cabinet.

The locker control column 1200 is formed with a housing 1202 that can be formed from metal stamping and bending so that the housing can accept a plurality of locker control modules 1204. The locker control column 1200 and locker control modules 1204 may be standardized so that the locker control column 1200 can be modularized and the locker control modules 1204 easily inserted or removed into the housing 1202 of the locker control column 1200 by a locker operator. The lock control module can be configured so that the locker control modules 1204 are oriented such that the lock control column can engage locker doors that open from the left, right, top or bottom of the locker door (requires orienting the locker control column 1200 oriented vertically or horizontally).

The locker control column 1200 can be manufactured separate from the lockers and shipped to the locker system location. In many installations, the lockers themselves require a significant amount of sheet metal that is closely to ship long distances. Thus, the locker control column 1200 can be manufactured and shipped to the locker location while the lockers and locker doors are sourced locally to reduce shipping Costs.

The same applies to the lock control modules 1202 which can be easily inserted in or removed from the locker control column 1200 as the locker sizes are configured. As the locker is resized, one or more locker control module 1202 may be taken out of commission as long as there is at least one locker control module 1202 per locker door. The locker door may also be resized if a locker control module 1202 needs to be removed for maintenance. The lock control modules 1202 may be located in the locker control column 1200. If a locker is configured to a sufficiently large enough size, one or more locker control modules 1202 may be taken out of service 1204 since only one locker control module 1202 is necessary for a given locker door size. In place of the missing locker control module 1202, a blank panel 1204 or an empty slot 1204 may exist in the locker control column 1200.

Also contained in each locker control channel may be a cable assembly that connects the locker control modules and the locking devices to a circuit board located in the locker control module (see FIG. 14). This The lock control modules may also include a set of indicators, which could alternatively be an alphanumeric display of at least one character, a set of LED lights of one or more colors indicating an available locker, a locker with packages stored in the locker, or error messages (flashing red and/or green LEDs may indicate problems requiring assistance from a locker operator), or an audio speaker for indicating visual/audible alarms or signaling regarding the status of the locker. The LEDs can provide event status such as (1) the locker is open; (2) the locker is closed; (3) a package is present in the locker; (4) whether the locker is empty; and (5) whether the locker door was forced open. Each of these events may also be captured by the lock control module and transmitted to a locker dashboard accessible by the e-commerce goods seller, the shipper and/or the locker operator. The LED lights can also provide visual information to a locker operator as to which locker to place a customer's packages or goods.

Incorporated within or adjacent to the locker control channel is a removable front stile 614 that when removed provides service access to the locker control channel, lock devices, control modules, user interface devices and the cabling. Through the cabling, each locker control module may be connected to the central locker control unit's microprocessor with a user input/output means such as a touchscreen monitor. Each locker's control module can communicate its electronic address to the central locker control unit's microprocessor, report status and respond to control signals addressed to the control module, enabling control of the locking devices. Alternatively, the electronic address may be set by the electronic control unit and communicated to the locker control module.

The locker control unit may communicate with the locker control modules and/or sensors to operate the lock engines that control access to the lockers. The communication between the locker control unit and the locker control circuitry may be wired or wireless. If the network is a wireless network, locker communications between the locker control unit and the locker control circuitry may be sent along an encrypted pathway.

The reconfigurable locker system facilitates rapid, reliable and cost effective field installation and operation of the locker systems. In addition, the intelligent locker system encourages a rapidly scalable market solution by separating the elements contained in the locker system from the actual locker cabinet construction from the locker control columns and related electronic hardware such as the locker control unit. Thus enabling a solution that can be produced by different and competing local locker cabinet manufacturers without requiring them to individually modify the design and manufacturing of their locker control columns such that the electrified lock devices, control modules, cabling, sensors and user interface devices could be installed directly into the locker cabinets whose sizes and construction have been standardized. The cabling can be individually installed in a locker control channel that is adjacent to a column of lockers. The locker control channel assembly can be manufactured and tested as one unit at an electronics manufacturing facility in a controlled assembly process, which will result in improved quality, reliability and cost effectiveness by streamlining the installation in the field.

FIG. 13 illustrates the modular construction of the locker control modules 1300. The locker control module 1300 slides into the locker control column 1302. The locker control module 1300 has a latch 1304 that engages the locker door. The locker control module 1300 can be slid into the locker control column 1302 and secured. The locker control module 1300 has electronic components that are powered and communicate with the locker control unit in the kiosk via an electronic communications cable. The locker control module 1300 may be slid into the locker control column 1302 and pin connects in the locker module can connect to an electronic interconnect 1308 fixed to a wire ribbon cable that allows the locker control module 1300 to plug into an electronic bus that ultimately connects the locker control modules. The pin connects may have the male/female connections so that female connections connect into male connection 1309. The locker control module 1300 can be secured in the locker control column 1302 by screws, a snap fit or other securing means that are inserted into holes 1310 using some securing mechanism that is well known to those in the metal fabrication industry. Lights 1312 and 1314 may be LEDs that provide visual feedback to customers and the locker operator that the package sensor has detected packages ready for pickup or that the locker is empty. Another opening (not shown) may be implemented for receiving a lock override tool to release a locker door if a locker control module malfunctions and refuses to release a locker door upon receipt of electronic commands.

The LED lights 1312 and 1314 on the locker control module 1300 can also be connected to a loudspeaker (not shown). As previously discussed, the LED lights 1312 and 1314 can provide status and/or troubleshooting information regarding the status of the locker and locker control module 1300. When the locker control module 1300 incorporates a sensor, additional information can be displayed with the LED lights 1312 and 1314 such as whether a package is present within the locker or whether the locker is empty. The locker control module may also include a reset button (not show) on the front face plate of the locker control module 1300 or behind the front face place where the locker control module 1300 must be partially or fully removed from the locker control column 1200.

Included within or adjacent to each locker is one or more proximity sensors that detect the presence of a package by use of optical technology. Each proximity sensor may be positioned to detect a package in a specific area within a locker, enhancing the ability to detect small packages even in large lockers. A proximity sensor may also be positioned to detect a thin package such as an envelope within the locker. The proximity sensor may comprise a weight sensor, an ultrasound sensor, an infrared sensor or a light sensor or any other sensor that can detect a package, including one that is as small as a letter. Associated with each proximity sensor may be an indicator means, such as a light emitting diode of one or more colors, or an audible speaker, to provide a visual or audible indication of whether or not a package has been detected in a locker. The locker enclosure may include a geometrical embodiment to assist the operator to position the package such that the ability of the proximity sensor to detect the package is enhanced. The indicator means alerts an operator such as a retail clerk or delivery driver that the package has been properly positioned in the locker to be detected by the sensor.

Other embodiments may assist the sensor in detecting small, hard to detect letters and/or packages. A decal or label may be installed within the locker indicating the optimal position of the letter or package to trigger detection by the locker sensor. Instead of decals or labels, dimples may be formed on the locker floor/shelf for the optimal positioning of the letter or package.

Each sensor may be connected to or integrated with the locker control module, enabling the module to report package present status to the locker control unit. The insertion and removal of a package may be synchronized with the delivery and package pick-up operations to detect and report potential abnormal use of the lockers for security purposes and to provide assurance that a package was delivered and retrieved.

The sensor may have a hard time detecting the presence of a small or lightweight letter or package. Thus, the locker shelf may be configured at a slight tilt upwards/downwards so that the sensor can detect the presence of the package/letter. In most situations, the sensor does not have to detect the entire presence of the locker space, but merely part of the locker space in order to detect the package/letter.

The sensors can also assist the locker system in detecting whether the locker door is open. The locker door and locker control module can be configured to close and relock the locker door. An advantage of having the locker system automatically able to relock the locker doors is to protect the integrity of the locker system. Also, this feature can be especially important when the locker is refrigerated and the customer has picked up the goods, but in doing so left the locker door open. Having the locker system issue an alert and/or automatically closing and relocking the locker door would be essential in such a design configuration. The locker system could also be configured so that the locker door automatically relocks after a predetermined period of time. To implement the closing of the locker doors, springs may be added so that the locker doors automatically shut. The locker system could then engage or disengage the locks so that the locker doors lock or unlock. Another embodiment could use motors to ensure that the locker doors move to the closed position.

FIG. 14 illustrates a rear angle perspective view of the locker control module 1400. The locker control module 1400 may be designed as a plug and play module that can easily be inserted or removed from the locker control column's housing (not shown). A front bracket 1402 and slide bracket 1404 can assist in positioning and securing the locker control module 1400 in the locker control column. A lock engine 1406 can be secured with the front bracket 1402 and the slide bracket 1404 to form the locker control module 1400. The lock engine 1406 has a latch mechanism 1408 that functions to open or close and latch/secure the locker door.

Interfacing with the lock engine 1406 is lock control circuitry or a PCB board 1410 that electronically connects to a power cable and communications cable via a connector 1412 which holds the pins 1414 for connecting into a female connector that connects the pins 1414 to the ribbon cable (see FIG. 15). In one embodiment, the power cable can be integrated into the same cable as the communications cable so that the lock mechanism's pins 1414 can connect with a female connector that may be built into the locker control column positioned adjacent to the rear portion of the locker control column's housing (see FIG. 15). The male/female pin orientation could be reversed with the pins (male connector) 1414 located in a connector on the cable and the female connector located on the locker control module 1400.

When the locker control module 1400 is manufactured, a unique electronic address may be assigned to the locker control module 1400. When the locker control module 1400 shipped to the locker location, it can be plugged into the locker control column and the locker control unit can recognize its address. When a locker control module 1400 is enabled or disabled, the locker management software operating locally on the locker control unit connected to the locker control circuitry can control the locker control module's 1400 functionality, including whether to enable or disable the sensors, lights or audible alarms.

An alternative embodiment may position the lock engine 1406 or the latch mechanism 908 separate from the lock column. In such an embodiment, the locker control module may comprise the lock control circuitry 1410 and the wire cable connections to the kiosk. In another embodiment, the lock column may include the locker control module 1400, but have the lock control circuitry 1410 located separate from the lock column. In another embodiment, the wire cable provides power to the locker control module and LCD lights, but the communication between the various locker control modules and the kiosk is accomplished by a wireless network.

FIG. 15 illustrates a rear angle perspective view of the locker control column 1500. A cut away view 1502 of the locker control column 1500 provides an interior view of the locker control module 1504 secured within the locker control column 1500 illustrating an electronic connector fits into the plug 1506 which in turn connects to a wire ribbon or cabling 1508. The wire ribbon or cabling 1508 provides the power and communication linage to the kiosk. The wire ribbon or cable assembly 1508 may be pre-configured with connectors 1506 located at each stations position in the locker control channel matching locations where the lock control modules 1504 may be located. The wire ribbon or cabling 1508 connects the locker control module 1504 with the kiosk by running this wire ribbon or cabling directly to the kiosk.

For ease of the modular assembly of locker control columns, another wire (not shown) could be run along the top or bottom of the locker control column hoosing with connectors to connect two or more wire ribbons or cabling 1508 to the kiosk. Such a configuration would ease installation and maintenance because prior art locker configurations currently require individual wire cabling to be properly sized and run from electronic locks to the kiosk. This requires a substantial number of wires to be properly sized and correctly installed for unlock signals to pass from the kiosk to the locks. This invention eliminates the need for distinct wiring of power and communication cables from the kiosk to the individual locker lockers.

The lock control unit does not have to be located within the kiosk, but the controller should connect with a human machine interface that allows customers to input access codes that causes the locker control modules to enable the lock engines to open the locker doors.

FIG. 16 is a perspective view of an optical sensor capable of detecting items within a locker. One issue that arises frequently with lockers is knowing when a package has been removed from a locker. One solution is to integrate a scale into the locker shelf that detects the weight of a package. Integration of a scale would need to detect packages as well as envelops. In addition to integrating a cost effective scale the scale would need to interface with the intelligence of the locker system so that electrical signals would pass from the scale to the electronics controlling the locker system. One challenge with scales is ensuring that wires are run to the scale providing power and a communications cable also connecting the locker system electronics to the scale so that weights or a package detector data is passed to the locker system electronics. One way to reduce the numbers of wires is to install a wireless connected scale. Of course, power would either still need to be provided by a wired connection or from batteries. If batteries are used for each individual locker shelf, maintenance costs as well as the costs of the batteries will drive up the operational costs of the locker system.

Other sensors that may be employed to detect the presence of a package or packages include the use of electromagnetic spectrum sensors. These sensors could range from ultrasonic, visible light or infrared sensors. One optical sensor that may be employed includes the transmission visible light. The distance the light travels can be measured accurately. When the light sensor is installed, the distance the light travels to the other side of the locker can be measured with the distance reflecting off the locker wall. This distance may be used as the benchmark for an empty locker. When a package is inserted into the locker, the measured distance the light travels will be less than the distance traveled if the light was reflecting off the locker wall. Thus, a package can be detected when the distance the light travels is less than the benchmark.

Once challenge is when an envelope is inserted into the locker. When laid flat the envelope becomes hard to detect, especially when the envelope is substantially smaller than the locker shelf. Thus, the light sensor should be positioned to detect the presence of packages as well as envelopes that are laid flat on the locker shelf FIG. 16 illustrates one such light sensor module 1600. The light sensor module 1600 may include one or more light sensors 1602 and 1604. A first light sensor 1602 may be positioned within the light sensor module 1600 at different angles so that they cover the locker shelf and can detect envelopes and packages. This can be accomplish with at least one and potentially more than one light sensor 1602 and may be arranged such that the first light sensor 1602 is positioned at a fifteen (15) degree angle (first angle) relative to the longitudinal body of the light sensor 1600 and a second light sensor 1604 may be positioned at a forty-five (45) degree angle (second angle) relative to the longitudinal body of the light sensor 1600.

The sensors can cover the x, y, and z planes. The challenge becomes detecting an envelope laid flat in a large locker. In large lockers, the lock control module that is typically enabled is located in the center of the height of the locker. This often presents a challenge as the sensor has to search for small items that may be left in a large locker such as an envelope. To overcome this problem, dimples may be placed in the top of the locker shelf so that the envelop sits up slightly off the shelf enabling the sensor to more easily detect the envelope.

Another solution is to enable only the sensors on locker control modules that are positioned lower than the one that has the lock engine engaged to secure the locker door. In such a scenario, the locker control unit would know based on the configuration of the locker which locker control module has the lock engine enabled. Other locker control modules in the same locker control column that are aligned with the locker of interest can have their lock engines disabled, but their sensors enabled to assist in detecting packages and envelopes. As a further way to enhance small package detection and/or envelope detection is to place a visual indicator on the locker shelf that would encourage the placement of items such as envelopes in a designated area for easier detection by the sensor. These sweet spots may be a visual indicator such as a tape layout for the location of an ideal place to place an envelope or the placement of a red dot indicating the ideal location for positioning a package inside the locker.

Also, another solution would be to have the sensors enabled and connected to the lock control circuitry, but positioned separate from the lock control module. In such an embodiment, the locker control unit could detect the appropriate sensor and enable that sensor within the locker of interest. The sensors could also be positioned so that scanning the shelf area is optimized. With the shelf position continuously changing, the sensors' could be redirected with standard beamforming technology so that the sensors are recalibrated upon a locker reconfiguration for the detection of packages and items that will be positioned on the locker shelf.

The sensors can also be networked to the locker control unit through the locker control circuitry so that the sensors can prove improved diagnostics as well as package detection functionality that can be communicated to the locker control unit by a wired or wireless connection. The locker control module may have a sensor enabled, but the lock engine is not enabled. An alternative embodiment could allow the incorporation of a sensor at every level where there is a slot conformed for inserting or removing a locker shelf.

Female pin connectors 1606 may be positioned on the side opposite the side where the light is emitted from the light sensors 1602 and 1604. These female pin connectors 1606 provide part of the interconnect between the light sensor 1600 and the locker control module and support the supply of power to the light sensor 1600 as well as electrical signals from the light sensor to the locker control module electronics. The light sensor module 1600 may be secured to the locker control module with a screw through screw hole 1608.

FIG. 17 is a perspective view of an optical sensor modularly plugging into a locker control module. The light sensor module 1700 may be secured to the locker control module 1702 as a snap in connection, a slide-in connection, by a screw or other means well known to one skilled in the art. The female pin connectors (not shown) can connect to the male pin connections 1704 thus connecting the power, electrical signal and/or data connections between the light sensor module 1700 and the electronic components controlling the locker control module 1702.

FIG. 18 is a flow chart of the initialization of lockers for the acceptance of package(s). The locker control column 1800 may be manufactured in a stand-alone unit structure and shipped with or without the kiosk module. In some instances, the locker control column may be manufactured by the locker cabinet manufacturer. In other instances, the locker control column manufacturer may be a different entity than the locker cabinet manufacturer. This second scenario may be preferable when the locker site is in a remote location or in a location where shipping the locker cabinet (typically high strength plastic or sheet metal forming the actual locker is not cost effective). In these situations, a locker cabinet manufacture located near to the locker site may be engaged to construct the locker cabinet(s) with a place reserved for the locker control column that is located adjacent to the actual locker.

Once at the locker cabinet manufacturer or the locker site, the locker control columns may be installed in the locker cabinet. The locker control modules can then be inserted 1802 into the locker control column in positions that correspond with engagement with the locker doors. The lockers can then be configured and tested 1804 for supply of power to the locker control module and communication with the kiosk so that the kiosk can detect which lockers are operable and whether they can be locked and unlocked when an access code is entered into the kiosk. The locker manufacturer can then verify the sensor operability 1806.

FIG. 19 is a flow chart illustrating the configuration of the locker doors and shipping packages to a locker site for customer pickup. The locker operator may have personnel onsite that configures the locker system. The locker operator may have someone full time working at the locker site or the person who periodically delivers packages may be responsible for configuring the lockers. The configuration of the actual locker size may be done by the seller of goods, a shipper of package or the locker operator. In all of these scenarios and examples, the locker operator may be one of these organizations.

The locker operator may configure and size the lockers at the locker site based on the incoming sizes of the packages 1900. This can be accomplished manually with the locker operator examining the packages and making judgments about the optimal locker size. It can also be accomplished with software, especially when the data regarding the sizes of the packages being sent to the lockers is known. The software can calculate the dimensions of the packages and the optimal configuration of the lockers so that the locker operator can receive a message to reconfigure the lockers before or just after the packages arrive at the locker location. The locker operator may reconfigure the locker shelves and replace or reconfigure the locker doors to conform or correspond to the actual size of the reconfigured locker 1902. In an alternative embodiment, the locker door is not replaced but instead is connected to the locker door above and/or below to form one locker door 1904 as illustrated in FIG. 11.

Also, the locker operator may add or remove locker control modules that engage with the appropriate locker doors 1906. These locker doors and locker control modules may be tested to verify their correct operability 1908. Thus, the locker control modules may be easily added or removed from the locker control column after removal of the stile or the locker control module may be electronically brought online or offline (enable functionality/disable functionality) without actually removing the locker control module from the locker control column. Such an enabling and disabling capability of the locker control module would substantially reduce the time required for reconfiguring the lockers.

The locker operator may then insert the package(s) into the designated locker space 1910 and test to ensure that the sensors detect the presence of the package(s) 1912. This information may be uploaded into a database at the locker site or uploaded to the package shipper and/or goods seller 1914. The locker operator, package shipper and/or goods seller may then notify the customer that the packages are ready to be picked up at the locker location 1916. An access code may also be sent to the customer at the time the customer is notified that the packages are ready to be picked up 1918. Once the customer arrives at the locker site, the customer may be authenticated 1920 and by use of the access code 1922, the locker door(s) may open so that the customer can retrieve their package(s). In an alternative embodiment, the customer may be authenticated 1920 and enter their access code 1922 remotely from the locker if they have a trusted individual at the locker location to pick up the packages or goods.

FIG. 20 is a flow chart illustrating the shipment of goods or packages to a customer desired location. The locker system may also be used for returning of goods or packaging. The customer may go to the locker site 2000, input information such as authentication of the sender, payment information and a shipping label may be created 2002. The customer can then be assigned a locker 2004 and the packages placed in the locker 2006. If the customer has not packaged the goods for shipment, the goods can be left in the locker 2008 along with the shipping label and the locker operator may retrieve the goods from the locker 2010, package the goods in the shipper's containers and apply the shipping label 2012. The locker operator can then return the goods to the store's shelves or ship the goods 2014.

FIG. 21 is a flow chart illustrating the shipment of goods by a seller or package shipper to a locker location for customer pickup. If a customer orders goods 2100, the goods seller may assemble packages of known, standard package sizes 2102. The seller can then provide the packages to a shipper 2104 and either the goods seller or the shipper can select the appropriate locker site that is most convenient to the customer for later pick up of the packages 2106. Once the packages are picked up for shipment 2108, the customer may be notified of the locker location, locker number (if known) and access code 2110.

Once the customer arrives at the locker site to retrieve the goods, the customer may be authenticated by the input of information known by the goods seller and/or shipper 2112, and the customer can enter the access code at the locker kiosk or on the customer's mobile device 2114 enabling the locker door(s) to open for the customer to retrieve their packages 2116.

While various embodiments of the invention have been described, it will be apparent to those of ordinary skill in the art that many more embodiments and implementations are possible that are within the scope of this invention.

What is claimed is:

1. A reconfigurable locker system, comprising:
a locker cabinet comprising at least one locker that has reconfigurable shelves so that the at least one locker size can be adjusted and additional lockers added or subtracted by the addition or removal of the reconfigurable shelves;
a locker control column further comprising a first locker control module having a lock where the locker control module is electronically coupled to a locker control unit; and
at least one locker door forming the at least one locker where the lock engages the at least one locker door to secure the locker.
